(19) United States
(12) Patent Application Publication
(10) Pub. No.: US 2024/0317370 A1
(43) Pub. Date: Sep. 26, 2024

(54) WATERCRAFT RIDE ASSIST METHOD AND SYSTEM

(71) Applicant: Kai Concepts, LLC, Alameda, CA (US)

(72) Inventors: Donald Lewis Montague, Paia, HI (US); Merten Stroetzel, Pacific Palisades, CA (US); Alec Korver, Monument, CO (US); Mikael Nils Andreas Sundberg, Tyresö (SE); Leif Jakob Teodor Kuttenkeuler, Saltsjö-Boo-Boo (SE); Christopher Roy Slice, Colorado Springs, CO (US)

(21) Appl. No.: 18/603,657

(22) Filed: Mar. 13, 2024

Related U.S. Application Data
(60) Provisional application No. 63/491,220, filed on Mar. 20, 2023.
(60) Provisional application No. 63/491,201, filed on Mar. 20, 2023.
(60) Provisional application No. 63/604,972, filed on Dec. 1, 2023.

(51) Int. Cl. B63B 79/40; B63B 32/10; B63B 32/64; B63B 79/10; B63H 21/17; B63H 21/21

(52) U.S. Cl. CPC B63B 79/40; B63B 32/10; B63B 32/64; B63B 79/10; B63H 21/17; B63H 21/21; B63H 2021/216

(57) ABSTRACT

A watercraft is provided that includes a support platform having a bottom surface. The watercraft includes a hydrofoil disposed on a strut extending from the bottom surface of the support platform. The watercraft includes a propulsion system coupled to the bottom surface of the board such that a thrust generated by the propulsion system moves the board through a body of water. The watercraft includes a position sensor, a speed sensor, and an altitude controller. The position sensor is configured to output position data of the watercraft relative to a surface of water. The speed sensor is configured to output speed data of the watercraft. The altitude controller is configured to adjust the thrust generated by the propulsion system based at least in part on a ride height derived from the position data and a speed derived from the speed data to achieve a target ride height.

### CROSS-REFERENCE TO RELATED APPLICATIONS

This application claims the benefit of U.S. Provisional Application No. 63/491,220, filed Mar. 20, 2023, U.S. Provisional Application No. 63/491,201, filed Mar. 20, 2023, and U.S. Provisional Application No. 63/604,972, filed Dec. 1, 2023 which are all hereby incorporated herein by reference in their entireties.

### FIELD

This disclosure relates to a method and system for simplifying control of a watercraft, such as a weight-shift controlled hydrofoiling watercraft.

### BACKGROUND

Some watercraft include hydrofoils that extend below a hull or board on which one or more users ride. As such hydrofoiling watercraft are propelled through the water, the water flowing over the hydrofoil provides lift causing a portion of the watercraft to be lifted upward and out of the water. Advantages of this design include a significant reduction in drag. This reduction in drag may enable a personal hydrofoiling watercraft to operate for longer periods of time. In the context of electric hydrofoiling watercraft, the hydrofoil may also enable use of a smaller battery such that the watercraft is lighter and more maneuverable. Examples of such hydrofoiling watercraft include the personal hydrofoiling watercrafts disclosed in U.S. Pat. No. 10,940,917, which is incorporated herein by reference in its entirety. Personal hydrofoiling watercraft provide the rider with an exhilarating sense of “flying” or “gliding” over the water and are rapidly becoming popular recreational devices.

Controlling existing weight-shift controlled personal hydrofoiling watercraft, however, requires significant balance and practice. Existing personal hydrofoiling watercraft may be controlled using the rider's weight to pitch or roll the watercraft. By pitching the nose of the watercraft up and/or increasing the throttle, for example, the rider can increase the ride height of the watercraft. Increasing the ride height of the board places the rider on a more precarious platform because the board is supported on a larger lever arm above the water. In addition, increasing the ride height such that the propulsion system or the hydrofoil of the watercraft breaches the surface of the water will cause the watercraft to rapidly decelerate and often causes the rider to lose balance or fall off the board. Alternatively, the rider may pitch the nose of the watercraft down and/or decrease the throttle to reduce the ride height of the watercraft. Decreasing the ride height of the board too much may bring the board into contact with the surface of the water, which will rapidly decelerate the watercraft and often cause the rider to lose balance or fall off the board.

### BRIEF DESCRIPTION OF THE DRAWINGS

FIG. 1 is a perspective view of a personal hydrofoiling watercraft including a ride assist system.

FIGS. 2A, 2B, and 2C are side views of the personal hydrofoiling watercraft of FIG. 1 with a ride-height sensor according to various embodiments.

FIG. 3 is a block diagram showing components of the personal hydrofoiling watercraft of FIG. 1.

FIG. 4 is a side view of the personal hydrofoiling watercraft of FIG. 1 illustrating measurements and forces used to implement the ride assist system.

FIG. 5 illustrates various states of control for the personal hydrofoiling watercraft of FIG. 1 in a ride assist mode.

FIG. 6A is a diagram showing a control loop of the ride assist system for the personal hydrofoiling watercraft of FIG. 1.

FIG. 6B is a state diagram illustrating various modes of operation used to control the personal hydrofoiling watercraft of FIG. 1 with the ride assist system.

FIG. 7 is a plot showing the effect of speed and user input for one example of the ride assist system of the personal hydrofoiling watercraft of FIG. 1.

FIGS. 8A and 8B are example plots showing measured values and calculated control inputs for a period of operating the personal hydrofoiling watercraft of FIG. 1 with the ride assist system.

FIGS. 9A and 9B are example plots showing measured values and calculated control inputs for a period of operating the personal hydrofoiling watercraft of FIG. 1 with the ride assist system.

FIG. 9C is a plot corresponding to the plots in FIGS. 9A and 9B, illustrating ride-height measurements and calculated values for a period of operating the personal hydrofoiling watercraft of FIG. 1 with the ride assist system.

FIG. 10A is a side elevation view of a propulsion unit pivotably mounted to a strut of the personal hydrofoiling watercraft of FIG. 1 to adjust the direction of thrust provided by the propulsion unit.

FIG. 10B is a side elevation view similar to FIG. 10A with the propulsion unit pivoted upward.

FIG. 10C is a side elevation view similar to FIG. 10A with the propulsion unit pivoted downward.

FIG. 11A is a side elevation view of a portion of a propulsion unit of the personal hydrofoiling watercraft of FIG. 1 including guide vanes.

FIG. 11B is a cross-section view of a portion of the propulsion unit of FIG. 11A with the guide vanes in a first position.

FIG. 11C is a cross-section view of a portion of the propulsion unit of FIG. 11A with the guide vanes in a second position.

FIG. 11D is a cross-section view of a portion of the propulsion unit of FIG. 11A with the guide vanes in a third position.

FIG. 12 is a block diagram showing a ride assist system of the personal hydrofoiling watercraft of FIG. 1 according to another embodiment.

FIG. 13 is an example plot showing input and output values of the ride assist system of FIG. 12 during a period of operation of the personal hydrofoiling watercraft of FIG. 1.

### DETAILED DESCRIPTION

As described above in the background, in existing personal hydrofoiling watercraft the ride height of the watercraft can be controlled by the rider using the throttle and shifting their weight on the board. Control of the ride height of the board may be a balancing act that requires practice and experience. For example, to control of the ride height of existing hydrofoiling watercraft, the user must shift their weight on the board to counter all other forces acting on the board, including the thrust provided responsive to a throttle input. Novice riders often have difficulty controlling or maintaining a desired ride height because the riders are not properly shifting their weight on the board as they change the throttle input, for example, to keep the board substantially level to avoid changing ride height or at a desired pitch to adjust the ride height in a controlled manner. Additionally, a novice rider may not recognize that they are leaning forward or backward (or how far they are leaning), which may attenuate or amplify the effect a change in throttle input has on the ride height of the watercraft. Moreover, providing too large of a change in the throttle input may require the rider to shift their weight substantially to prevent a rapid change in either ride height or pitch of the board.

Novice riders further may have difficulty assessing ride height during operation of the watercraft. Visually estimating ride height takes practice and may be challenging in certain water conditions, for example when the water surface is particularly smooth. Additionally, when a rider discovers that the watercraft is being operated at too high of a ride height, the rider may not be able to control the watercraft to lower the ride height without losing their balance or falling off the board.

The challenges described above also make riding a personal hydrofoiling watercraft difficult even for experienced riders. A momentary lapse of focus could cause the rider to lose balance or fall off the board. A ride assist method and system for hydrofoiling watercraft, including personal hydrofoiling watercraft, are disclosed herein to address these challenges by simplifying control of a hydrofoiling watercraft as described herein.

The ride assist system disclosed herein may receive data from sensors of the watercraft and adjust the throttle of the watercraft to drive the watercraft through the water and achieve and maintain a desired ride height. By employing the ride assist system described herein, from the rider's perspective, to control the watercraft the rider leans forward to increase speed and leans backward to decrease the speed. The ride assist system automatically adjusts the throttle based on the pitch of the watercraft and/or a detected change in the ride height. The difficulty in operating the watercraft is greatly reduced because the rider need not engage in the careful weight-shift balancing act described above because their weight shift in essence controls the throttle as described in further detail below.

In some aspects, the techniques described herein relate to a watercraft including a support platform (e.g., a board or hull) having a top surface and a bottom surface. The watercraft includes a propulsion system coupled to the bottom surface of the board such that a thrust generated by the propulsion system is configured to move the board forward through a body of water. The watercraft includes an orientation sensor configured to output orientation data of the board and a speed controller communicatively coupled to the orientation sensor and the propulsion system. The speed controller is configured to adjust the thrust generated by the propulsion system based at least in part on an orientation behavior of the board derived from the orientation data. For example, as the rider leans forward on the board such that the upward pitch angle of the board is decreased, the speed controller increases the throttle control signal to increase the thrust generated by the propulsion system. And, as the rider leans backward on the board such that the upward pitch angle of the board is increased, the speed controller decreases the throttle control signal to decrease the thrust generated by the propulsion system.

In some aspects, the techniques described herein relate to a watercraft including a board having a top surface and a bottom surface, a strut extending from the bottom surface of the board, and a hydrofoil disposed along the strut. The watercraft includes a propulsion system coupled to the strut such that a thrust generated by the propulsion system is configured to move the board forward through a body of water. The watercraft includes a position sensor, a speed sensor, and an altitude controller communicatively coupled to the position sensor, speed sensor, and the propulsion system. The position sensor is configured to output position data of the hydrofoiling watercraft relative to a surface of the body of water. The speed sensor is configured to output speed data of the hydrofoiling watercraft. The altitude controller is configured to adjust the thrust generated by the propulsion system based at least in part on a ride height derived from the position data and a speed derived from the speed data to achieve a target ride-height. For example, when the rider leans back on the board (increasing the upward pitch angle of the board), the altitude of the watercraft above the surface of the body of water may begin increasing. The altitude controller may reduce the thrust generated by the propulsion system an amount sufficient to stop the altitude of the watercraft from increasing to achieve and maintain the desired ride height. The speed of the watercraft may also be reduced as the thrust of the propulsion system is reduced. As another example, when the rider leans forward on the board (decreasing the upward pitch angle of the board), the altitude of the watercraft above the surface of the body of water may begin decreasing. The altitude controller may increase the thrust generated by the propulsion system an amount sufficient to stop the altitude of the watercraft from decreasing to achieve and maintain the desired ride height. The speed of the watercraft may also be increased as the thrust of the propulsion system is increased. In some examples, the altitude controller adjusts the thrust generated by the propulsion system by changing a direction of the thrust of propulsion system, for example, by pivoting the propulsion system upward or downward.

In some aspects, the techniques described herein relate to a watercraft including a support platform having a top surface and a bottom surface, a strut extending from the bottom surface of the support platform, and a hydrofoil disposed along the strut. The watercraft includes a propulsion system coupled to the strut such that a thrust generated by the propulsion system is configured to move the support platform forward through a body of water. The watercraft includes an orientation sensor configured to output orientation data of the support platform and a controller communicatively coupled to the orientation sensor and the propulsion system. The controller is configured to control the thrust of the propulsion system and to adjust the thrust based at least in part on an orientation behavior of the support platform derived from the orientation data. The controller may receive a user input signal from a wireless controller (e.g., movement of a trigger or thumbwheel) to control the throttle of the propulsion system or may output a throttle control signal independent of the wireless controller to position the platform at a target height above a surface of the body of water. The controller may adjust the throttle control based on orientation behavior of the support platform, for example, based on a pitch rate and/or pitch acceleration of the board. For example, where the pitch of the support platform is increasing, the controller may reduce the throttle control signal (e.g., an amount proportional to the pitch rate) to account for the increasing pitch of the support platform to minimize the immediate impact of the change in pitch on the ride height of the support platform. Likewise, where the pitch of the support platform is decreasing, the controller may increase the throttle control signal (e.g., an amount proportional to the pitch rate) to account for the decreasing pitch of the support platform to minimize the immediate impact of the change in pitch on the ride height of the support platform.

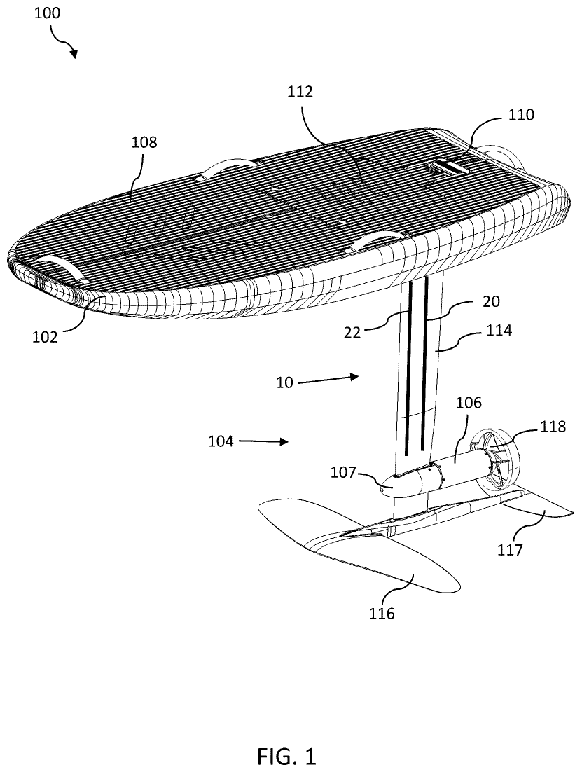

With respect to FIG. 1, an example of a personal hydrofoiling watercraft 100 including a ride assist system 600 is provided. The illustrated hydrofoiling watercraft 100 has a board 102, a hydrofoil 104, and an electric propulsion unit 106 mounted to the hydrofoil 104. The board 102 may be a rigid board formed of fiberglass, carbon fiber or a combination thereof, or an inflatable board. The top surface of the board 102 forms a deck 108 on which a user or rider may lay, sit, kneel, and/or stand to operate the watercraft 100.

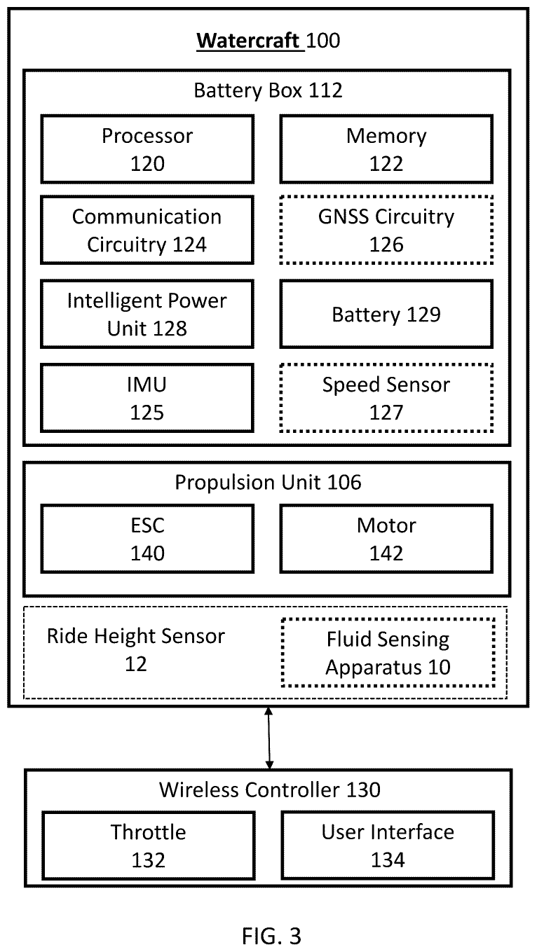

The hydrofoiling watercraft 100 may include a battery box 112 that is mounted into a cavity 110 on the top side of the board 102. The hydrofoil 104 includes a strut 114 and one or more main hydrofoil wings 116 and secondary hydrofoil wings 117. The propulsion unit 106 may be mounted to the strut 114 with a bracket 107 that permits the propulsion unit 106 to be mounted to or clamped onto the strut 114 at varying heights or positions along the strut 114. The strut 114 may be formed of fiberglass, plastic, aluminum, and/or a carbon fiber. Power wires and/or a communication cable may extend through the strut 114 from the battery box 112 to the propulsion unit 106 to provide power and operating instructions to the propulsion unit 106. The propulsion unit 106 may contain an electronic speed controller (ESC) 140 and a motor 142 (both illustrated in FIG. 3). In some embodiments, the propulsion unit 106 also includes the battery and/or an intelligent power unit (IPU). The motor 142 includes a shaft that is coupled to a propeller 118. Rotation of the shaft turns the propeller which provides thrust that drives the watercraft through the water. In other forms, a waterjet may be used in place of the propeller 118 to drive the watercraft through the water.

As the hydrofoiling watercraft 100 is driven through the water by way of the propulsion unit 106, the water flowing over the hydrofoil wings 116 and 117 provides lift. This causes the board 102 to rise above the surface of the water when the watercraft 100 is operated at or above certain speeds such that sufficient lift is created. While the hydrofoil wings 116 and 117 are shown mounted to the base of the strut 114, in other forms, the hydrofoil wings 116 and 117 may extend from the propulsion unit 106. The propulsion unit 106 thus may be a fuselage from which hydrofoil wings 116 extend. In some forms, the hydrofoil wings 116 and 117 are mounted above the propulsion unit 106 such that the distance from the board 102 to the hydrofoil wings 116 and 117 is less than the distance from the board 102 to the propulsion unit 106. In the form shown, the hydrofoil wings 116, 117 include no movable control surfaces and the ride assist system 600 may control the operation of the watercraft 100 solely by adjusting the thrust of the propulsion unit 106. As used herein, movable control surfaces are surfaces that are able to be moved during operation of the watercraft 100 to control the behavior of the watercraft 100. In some forms, the hydrofoil wings 116 and 117 and/or the propulsion unit 106 include movable control surfaces that may be adjusted to provide increased or decreased lift and/or to steer the watercraft 100. For instance, the movable control surfaces may be pivoted to adjust the flow of fluid over the hydrofoil wing or the propulsion unit 106 to adjust the lift provided by the hydrofoil wing, increase the drag, and/or turn the watercraft 100.

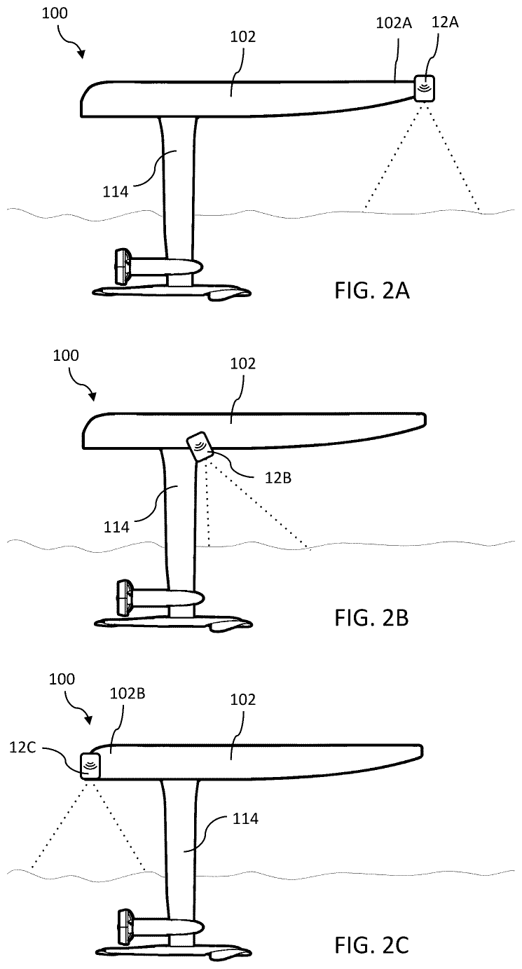

The hydrofoiling watercraft 100 may include a position sensor, such as ride height sensor 12 (see FIG. 3), that detects the position of the board 102 relative to the surface of the water, for example, how high the board of a personal hydrofoiling watercraft is flying above the surface of the water. With reference to FIGS. 2A-2C, the hydrofoiling watercraft 100 may include a ride height sensor 12A, 12B, and/or 12C (collectively referred to as ride height sensor 12). Ride height sensor 12 may be, for example, an ultrasonic and/or mmWave radar. The ride height sensor 12 may include multiple sensors, for example, to account for waves at the surface of the water. User of multiple ride height sensors may also be used to calculate a pitch angle or roll angle of the board 102, for example, by having sensors mounted on opposite sides of the board or strut of the watercraft (e.g., at the front and rear and/or on the left and right sides). Although FIGS. 2A-2C each illustrate a single sensor, a suite of sensors, such as one or more of the sensors 12A, 12B, and 12C, may be placed on a single personal hydrofoiling watercraft 100. The ride height sensor 12 may include other types of sensors and systems for determining the ride height of the board 102 such as those disclosed in U.S. Pat. Pub. 2021/0347442, which is incorporated by reference herein in its entirety.

With reference to FIG. 2A, the ride height sensor 12A is illustrated mounted at a nose portion 102A of the board 102. This position advantageously gives the controller in personal hydrofoiling watercraft 100 time to calculate the ride height, including by filtering the ride height to account for waves at the surface of the water before the strut 114 passes through such waves.

With reference to FIG. 2B, the ride height sensor 12B is illustrated mounted at the top of the strut 114. The ride height sensor 12B may be mounted to the strut 114 or mounted to the portion of the board 102 adjacent to where the strut 114 mounts to the board 102. This position advantageously minimizes the need to run wires through the board 102, because wires are already run through the strut 114 from the propulsion unit 106 to the battery box 112 as discussed above.

With reference to FIG. 2C, the ride height sensor 12C is illustrated mounted at a rear portion 102B of the board 102. To the extent other sensors or hardware are similarly mounted in the rear portion 102B of the board 102, positioning the ride height sensor 12C at the rear of the board may advantageously combine multiple components at a single location.

In other forms, the ride height sensor 12 may an upward facing sensor mounted to a portion of the watercraft 100 below the surface of the water that measures the distance to the surface of the water from below the surface of the water. The ride height of the board 102 may be calculated based on the measured distance.

Ride height sensor 12 may include a fluid sensing apparatus 10 which may be provided in addition or as an alternative to the wave-based sensors (e.g., ultrasonic, hydroacoustic and/or mmWave radar). With reference to FIG. 1, the hydrofoiling watercraft 100 may include a fluid sensing apparatus 10 that may be used to monitor the position of the board 102 relative to the surface of the water, as described in U.S. Application No. 63/491,201. The source electrode 20 and receiver electrode 22 may be mounted to the strut 114. Conductors, such as wires, may extend from the electrodes 20, 22 to the battery box 112 and the battery box 112 may include additional components of the fluid sensing apparatus 10. For example, the conductors may extend to the battery box 112 along with the power and communication wires extending to the propulsion unit 106. For instance, the conductors may be electrically connected to the battery box 112 via the connector disclosed in U.S. Pat. No. 10,946,939 which is incorporated by reference herein in its entirety. The fluid sensing apparatus 10 may include an impedance sensor, resistance sensor, and/or capacitive sensor that measures the impedance, resistance, and/or capacitance across the source electrode 20 and receiver electrode 22 to determine the portion of the electrodes 20, 22 submersed in the water.

With reference to FIG. 3, components of the personal hydrofoiling watercraft 100 are illustrated in block diagram form. Certain optional components of the watercraft 100 are illustrated in dashed line in FIG. 3. The battery box 112 (also shown in FIG. 1) may house a battery 129 for powering the watercraft 100, an intelligent power unit (IPU) 128 that controls the power provided to the electric propulsion unit 106, communication circuitry 124, one or more inertial measurement units (IMUs) 125, Global Navigation Satellite System (GNSS) circuitry 126, and/or a computer (e.g., processor 120 and memory 122) for controlling the watercraft or processing data collected by one or more sensors of the watercraft 100. The battery box 112 may be the device disclosed in U.S. patent application Ser. No. 17/920,662 titled “Battery for use in a Watercraft,” filed Oct. 21, 2022, and incorporated herein by reference in its entirety.

The processor 120 may be a general-purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The watercraft 100 may determine the location of the watercraft at any given time using the GNSS circuitry 126. From the location, the processor 120 may also calculate the speed and acceleration of the watercraft 100. In addition to the GNSS circuitry 126, the battery box 112 may include or be connected to a separate speed sensor 127. Other sensors may include the ride height sensor 12 such as an ultrasonic sensor, mmWave radar, and/or the fluid sensing apparatus 10, as discussed above. Data from the IMU 125 can similarly be used to identify the orientation, accelerations and speeds of the watercraft 100. Data from the IMU 125 may also be used to calculate location using a dead reckoning approach.

The communication circuitry 124 may be configured to communicate with a wireless remote controller 130 enabling a rider to control the hydrofoiling watercraft 100. The communication circuitry 124 may also be configured to communicate data and information with a remote computer, such as a server computer, via a network (e.g., cellular and/or the internet).

The wireless controller 130 may be the device disclosed in U.S. patent application Ser. No. 17/523,680 titled “Watercraft Device with a Handheld Controller,” filed Nov. 10, 2021, and incorporated herein by reference in its entirety. The wireless controller 130 includes a throttle 132 that may be, for example, a thumbwheel or a trigger used to control the thrust of the motor 142. The wireless controller may also include a user interface 134, including buttons, a programmable display, and/or a touchscreen used to control the watercraft 100. The user interface 134 may also allow the rider to set operating modes for the watercraft 100.

The watercraft 100 further includes the propulsion unit 106. The propulsion unit may incorporate the device disclosed in U.S. patent application Ser. No. 17/920,657 titled “Propulsion Pod for an Electric Watercraft,” filed Oct. 21, 2022, and incorporated herein by reference in its entirety. An electronic speed controller (ESC) 140 provides electrical power to the motor based on the control signals received from the IPU 128 of the battery box 112. In short, the ESC causes the shaft of the motor 142 to rotate and may also receive sensor data from the motor 142 indicating motor speed.

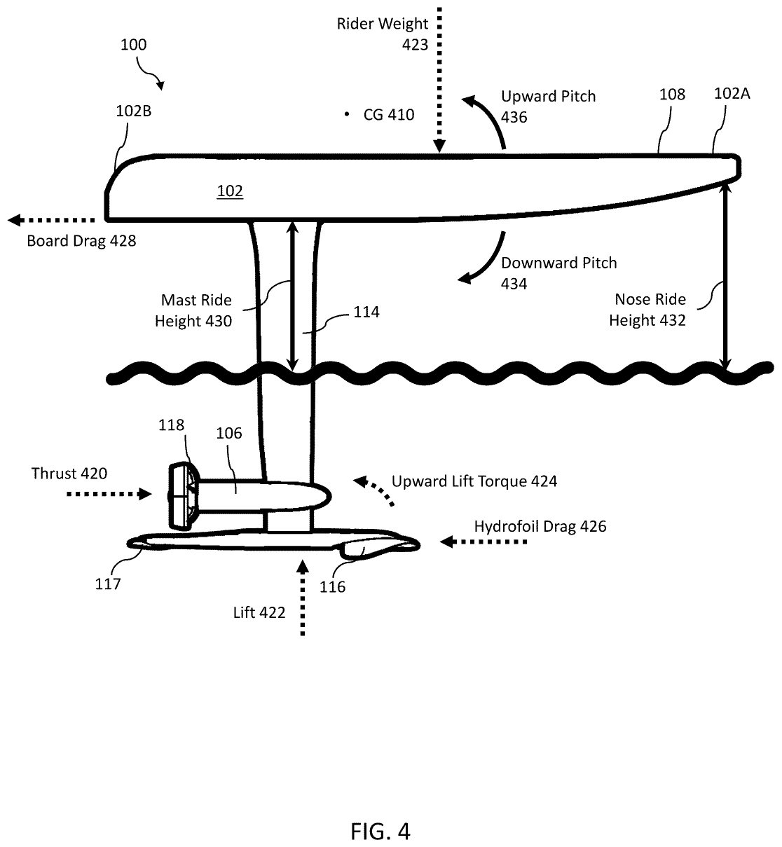

FIG. 4 illustrates forces acting on a personal hydrofoiling watercraft 100 and measurements used by the ride assist system 600. The top surface 108 of the board 102 supports a rider in a seated, standing, and/or prone position. The watercraft 100 together with the rider may have an approximate center of gravity 410 slightly above the top surface of the board 102. The center of gravity 410 may be different based on the weight and position of the rider and thus may vary over time. In preferred examples, the center of gravity 410 is approximately above the main hydrofoil 116.

The weight of the rider 423 is a force acting on the watercraft. The rider can pitch or roll the watercraft 100 by shifting their weight forward/rearward or side-to-side, respectively. For example, when riders shift their weight forward (e.g., toward the nose portion 102A) they can cause the board 102 to pitch downwardly as illustrated by the arrow 434. When riders shift their weight rearward (e.g., toward the rear portion 102B), they can cause the board 102 to pitch upwardly as illustrated by the arrow 436.

The lift 422 generated by the hydrofoil wings 116 and 117 acts to raise the watercraft 100 and rider out of the water. Lift 422 increases as the speed of the watercraft 100 through the water increases. The hydrofoil wings 116 and 117 also generate an upward lift torque 424 that could cause the board to pitch upwardly (see arrow 436) if not counteracted. The upward lift torque 424 increases as the speed of the watercraft 100 through the water increases.

The propulsion unit 106 (including propeller or jet 118) generates thrust 420 to propel the watercraft 100 through the water. The thrust 420 is not aligned with the watercraft's center of gravity 410. Changes in thrust 420 therefore tend to generate a pitching moment around the watercraft's center of gravity 410. For example, increasing the thrust 420 could cause the board 102 to pitch upwardly 436. Decreasing the thrust 420 could cause the board 102 to pitch downwardly 434. Hydrofoil always drag 426 acts against the thrust but varies depending on how much of the strut 114 is in the water. Hydrofoil drag 426 is substantially aligned with the thrust, however. When the board 102 contacts the surface of the water, board drag 428 acts on the board 102 but is not aligned with the thrust 420 and tends to generate a moment. Thus, while the watercraft 100 operates in a displacement or planning mode increasing the thrust 420 could cause the board to pitch upwardly 436. Board drag 428 is generally negligible when the board 102 flies above the surface of the water, although wind may affect how the board handles.

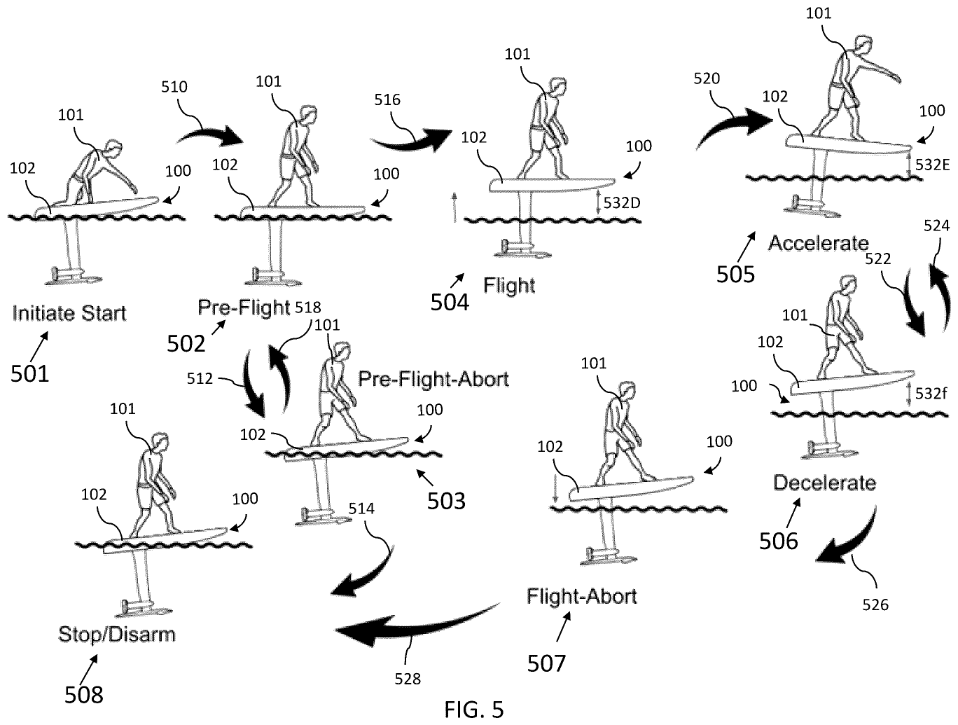

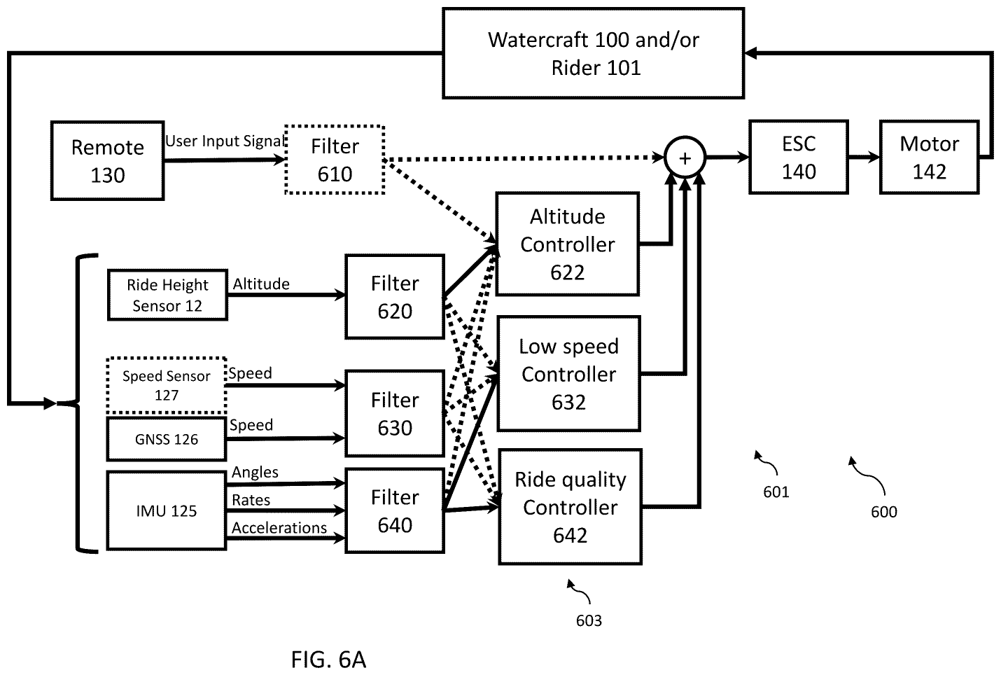

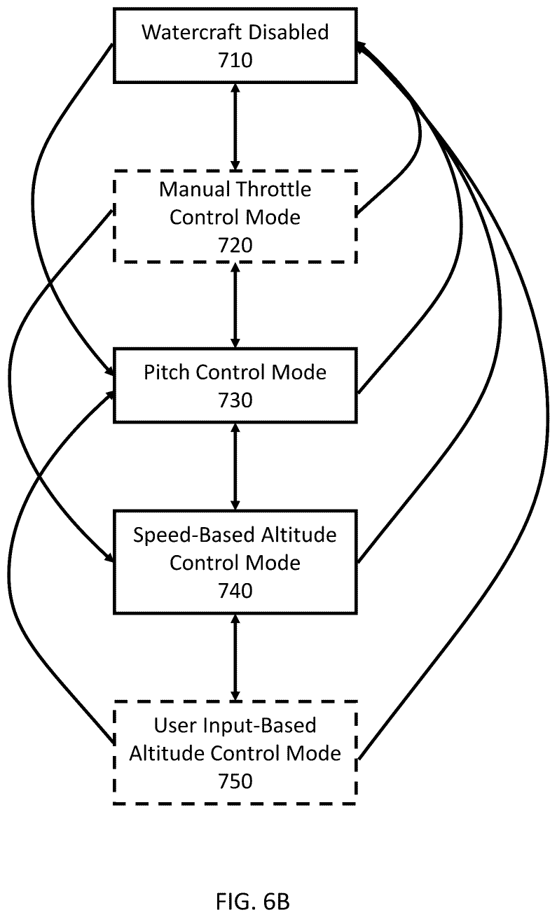

FIG. 5 illustrates operation of the watercraft 100 through various states 501-508, using a ride assist system and method that controls the watercraft 100 (e.g., adjusts the thrust of the propulsion unit 106) based on changes in the pitch or ride height of the board 102 as discussed in further detail below with respect to FIG. 6A. The ride assist system 600 enables a rider 101, for example, to control the hydrofoiling watercraft 100 by leaning forward or backward to change the pitch of the board 102. The rider 101 need not separately control the throttle of the watercraft 100, for example, with a user input mechanism of the wireless controller 130.

In state 501, a rider 101 is shown on the hydrofoiling watercraft 100 in an initiation mode in which the rider initiates the start of the ride assist system 600. The rider stands, kneels, sits, or lies prone on the top surface 108 of the board 102 with the upward pitch angle of the board 102 being about 10 degrees or greater. The hydrofoiling watercraft 100 may require the rider may enable the watercraft 100 or otherwise indicate the rider desires to begin operation by pressing a button on the board 102 or battery box 112 or on the wireless controller 130, or by providing a specific series of inputs on the wireless controller 130. The step of enabling the watercraft 100 may require a series of user inputs that make it highly likely that the user intends to enable the watercraft 100 and limiting the likelihood that the watercraft 100 is accidentally enabled. In one example, the watercraft 100 is enabled by placing a magnet (e.g., a magnet of a key of a kill switch) at a specific location on the board 102 or battery box 112. In one example, the watercraft 100 is enabled by touching or tapping the wireless controller 130 to designated portion of the watercraft 100, for example, on the battery box 112. Once enabled (if required) the watercraft 100 transitions to the preflight mode of state 502.

In state 502, the rider 101 is shown on the board in the pre-flight mode. In the pre-flight mode, the processor 120 may monitor the pitch angle of the board 102 using data output from the IMU 125. When the upward pitch angle of the board 102 is greater than a threshold (e.g., 10 degrees), the watercraft 100 does not operate the propulsion unit 106 and the board 102 may remain relatively stationary. To begin travel through the water, the user may shift their weight forward to decrease the pitch angle of the board 102 below the threshold at which point the processor 120 causes the propulsion unit 106 to operate. For example, to begin operating the watercraft 100 in the preflight mode, the user may decrease the upward pitch angle of the board 102 to less than 10 degrees. Upon the pitch angle of the board 102 falling below the threshold, the processor 120 operates the propulsion unit 106 to drive the watercraft 100 through the water and, as long as the user maintains the pitch angle of the board 102 below the threshold, may continue to increase the speed of the watercraft 100 up to the speed at which the hydrofoils 116, 117 provide adequate lift to raise the board 102 and rider 101 above the surface of the water. The processor 120 may monitor the pitch angle of the board 102 and may cause the watercraft 100 to accelerate based on the pitch angle. For example, the watercraft 100 may accelerate slowly where the pitch angle is only slightly below the threshold and may accelerate at increasingly greater rates as the pitch angle approaches a level pitch. As discussed above, the increased thrust of the propulsion unit 106 tends to pitch the board 102 upwardly, so the rider must counteract this tendency by maintaining their weight shifted forward on the board 102 to keep the pitch of the board 102 below the threshold (e.g., substantially level). In some embodiments, the board 102 of the watercraft 100 will start to lift off the water between 9-11 kts.

Staying on the board 102 during the transition from planing/displacement to flight is particularly difficult for novice riders. As the board 102 is lifted out of the water and takes flight, the forces acting on the board 102 shift dramatically. Board drag (428 in FIG. 4) becomes negligible. Without the ride assist system 600 described herein, the board 102 may pitch downwardly upon taking flight if the rider fails to shift their weight back on the board 102 as the watercraft 100 takes flight. Moreover, when the board 102 takes flight, less thrust is needed to maintain the same speed. An unassisted rider may therefore unintentionally accelerate the watercraft 100 by maintaining the same throttle position throughout the transition from planning to flight. Without adjusting the pitch of the board 102, the ride height of the watercraft 100 may continue to increase until the propulsion unit 106 and/or the hydrofoil wings 116 or 117 breach the surface of the water. The ride assist system 600 mitigates these effects, as discussed in further detail below, by automatically adjusting the thrust of the propulsion unit 106 as the board 102 reaches the speeds at which it takes flight to achieve a target ride height as the board 102 transitions to the flight mode. The ride assist system 600 may also automatically adjust the operation of the propulsion unit 106 based on the pitch angle of the board 102. For example, where the rider's weight is shifted forward, the ride assist system 600 may counteract the rider's forward lean (e.g., a low upward pitch or downward pitch) by increasing the speed of the motor 142 to increase the thrust of the propulsion unit 106. Where the rider's weight is shifted rearward (pitching the board 102 upward), the ride assist system 600 may automatically reduce the speed of the motor 142 to decrease the thrust of the propulsion unit 106 to maintain a predetermined ride height as the board 102 is progressively lifted out of the water to the desired ride height in the flight mode of state 504. Less thrust may be required where the board 102 has is an upward pitch angle because the direction of the thrust of the propulsion unit 106 has an upward pitch angle and the hydrofoil wings 116, 117 are angled upward.

As indicated by the arrow 516 from state 502 to state 504, the watercraft 100 enters a flight mode once the board 102 is lifted to a threshold height above the surface of the water. Alternatively, as indicated by the arrow 512 from state 502 to state 503, the watercraft 100 may transition to a preflight abort mode if the rider causes the board to slow.

In state 503, a rider 101 is shown causing the watercraft 100 to abort the pre-flight mode. By leaning rearward in the pre-flight mode, the rider pitches the nose of the board 102 upward such that the board 102 has an upward pitch angle. Upon detecting the upward pitch angle exceeds an abort threshold (e.g., 10 degrees relative to the surface of the water), the processor 120 decreases the motor speed to slow the watercraft 100. As indicated by the arrow 518 pointing from state 503 to state 502, the watercraft 100 returns to the pre-flight mode of state 502 if the rider 101 decreases the pitch angle of the board 102 below the pitch threshold (e.g., 10 degrees) which causes the watercraft 100 to accelerate as discussed above. Alternatively, as indicated by the arrow 514 pointing from state 503 to state 508, the watercraft 100 enters a stop/disarm mode, discussed below, if the rider 101 causes the watercraft 100 to slow to a stop and enter a disabled mode.

In state 504, a rider is shown on the board 102 in a flight mode. The flight mode uses speed-based altitude control to maintain a predetermined ride height 532D above the surface of the water. The altitude-based speed control may either replace or overlay the pitch-based control used at low speeds, as discussed below. As indicated by the arrow 520 pointing from state 504 to state 505, the rider can cause the board 102 to further accelerate in the flight mode. In state 505, a rider 101 is shown causing the watercraft 100 to accelerate in the flight mode. By leaning forward, the rider pitches the nose downward which decreases the ride height 532E of the board 102. Upon detecting this change in ride height via the ride height sensor 12, the processor 120 increases the motor speed to accelerate the watercraft 100 and maintain a desired ride height 532D. Increasing the motor speed increases the thrust of the propulsion unit 106 and also creates a moment about the center of gravity 410 of the watercraft 100 that counters the force of the rider pitching the nose downward and may cause the board 102 to pitch upward. Increasing the speed of the watercraft 100 also increases the lift generated by the hydrofoil wings 116, 117. In some examples the desired ride height 532D is a constant, predetermined value. In other examples, the desired ride height 532D is variable based on the speed of the board. In yet other examples, the desired ride height 532D is controlled by user input on the wireless controller's throttle. Each of these examples are discussed below. As indicated by the arrow 522 pointing from state 505 to state 506, the rider can cause the board to decelerate in the flight mode.

In state 506, a rider is shown causing the board to decelerate in the flight mode. By leaning backward, the rider pitches the nose of the board 102 upward and increases the ride height 532F of the board 102. Upon detecting this change in ride height via the ride height sensor 12, the processor 120 decreases the motor speed to slow the watercraft 100 and maintain a desired ride height 532D. As noted above, less thrust is required to maintain the ride height of the board 102 when the board 102 has an upward pitch angle because hydrofoil wings 116, 117 are angled upward and the thrust of the propulsion unit 106 has an upward component. As indicated by the arrow 524 pointing from state 506 to state 505, the rider 101 can again cause the watercraft 100 to accelerate in the flight mode. Alternatively, as indicated by the arrow 526 pointing from state 506 to state 507, the rider 101 can slow the watercraft 100 sufficiently to abort flight, thus exiting the flight mode.

In state 507, a rider 101 is shown causing the watercraft 100 to decelerate to a low speed such that the board aborts the flight mode. For example, when the rider leans back to cause the speed of the watercraft 100 to decrease below a threshold speed (e.g., approximately 9 kts), the watercraft 100 transitions to a landing sequence that causes the board 102 to descend in a controlled manner (progressively lower target ride heights) until no altitude of the board 102 is registered and the board 102 is in the water. Once the board is back in a displacement/planing mode of travel on the surface of the water, the watercraft 100 reverts to the pre-flight mode of state 502 or the stop/disarm mode of state 508.

As the watercraft 100 reverts to displacement/planning the forces acting on the board 102 again shift dramatically. Board drag (428 in FIG. 4) becomes significant. Without the rider assist system 600 described herein, the watercraft 100 may decelerate suddenly and/or the board 102 may pitch downward abruptly which may cause an unassisted rider to lose their balance and fall of the board 102. An unassisted rider may also increase the throttle as the board 102 reenters the water which may unintentionally pitch the board 102 upwardly. The ride assist system mitigates these effects, by automatically decreasing speed if the rider leans back to pitch the board 102 upwardly and/or by increasing the throttle if the rider maintains the board 102 at a level or downward pitch.

Once the board 102 is in the displacement/planing mode, the rider can cause the watercraft 100 to accelerate again by leaning forward to reenter the pre-flight mode illustrated in state 502. Alternatively, as indicated by the arrow 528 from state 507 to state 508, the watercraft 100 may transition to the stop/disarm mode of state 508, for example, when the watercraft 100 stops or the speed of the watercraft 100 falls below a threshold speed.

In state 508, a rider is shown causing the board to stop/disarm. By continuing to lean back in the pre-flight abort mode or flight abort mode, the rider causes the nose of the board 102 to remain at an upward pitch angle. Detecting this upward pitch, the processor 120 causes the watercraft 100 to continue to decelerate until the watercraft 100 coasts to a low speed or stop. The processor 120 may enter the stop/disarm mode upon detecting the watercraft 100 has stopped and/or has not received a control input for a period of time (e.g., 5 seconds). Alternatively, at any time and from any of the modes illustrated in states 501-507, the rider can disarm the watercraft 100 by pressing a button on the board 102 or battery box 112 or on the wireless controller 130, by releasing a kill switch, or by removing the safety magnet from the board. From the stop/disarm mode illustrated in state 508, the rider can once again initiate the start of the ride assist system starting from the actions illustrated and described with respect to state 501.

With respect to FIG. 6A, the ride assist system 600 includes a control loop 601. Certain optional components of the control loop are illustrated in dashed line in FIG. 6A. The person skilled in the art will recognize that such a control loop 601 could be implemented in hardware or software.

The ride assist system 600 includes a ride assist controller 603 having an altitude controller 622, low speed controller 632, and ride quality controller 642 that use input from sensors of the watercraft 100 to control the operation of the watercraft 100. The altitude controller 622, low speed controller 632, and ride quality controller 642 may be implemented primarily in hardware, or software, or a combination of hardware and software. For example, a hardware implementation may include using, for example, components such as ASICs, or FPGAs. Implementation of a hardware state machine capable of performing the functions described herein will also be apparent to those skilled in the relevant art. Given that the disclosure herein may be to physical hardware or software, the terms herein should not be limited to a software or hardware component, such as an FPGA or an ASIC, which performs certain tasks. For example, the steps and processes discussed herein may advantageously be configured to reside as code on an addressable storage medium and configured to execute on one or more processors, such as processor 120.

The ride assist system 600 may determine the ride height (altitude) of the board 102 above the surface of the water using sensors of the watercraft 100 including the ride height sensor 12. Signals from the ride height sensor 12 are passed through filter 620. The filter 620 may calculate average values, for example to normalize distances when the surface of the water is rough, choppy, and/or includes waves. The filter 620 may also include logic that compensates for potential errors generated by the ride height sensor 12. As examples, the filter 620 may remove noise and outliers from the collected ride height data. As another example, commonly used mmWave sensors are inaccurate when ride height drop below a certain height, for example, ten cm. Accordingly, the filter 620 may discard altitude signals from a mmWave sensor reporting less than a certain height (e.g., ten cm) and/or reduce the weight of the mmWave sensor data in determining ride height where multiple ride height sensors 12 are used to determine the ride height (e.g., where a suite of multiple types of ride height sensors are used). Altitude data (also referred to as ride height data) may be used in any of the altitude controller 622, low speed controller 632, and ride quality controller 642.

The ride assist system 600 may determine the speed of the watercraft 100 using sensors of the watercraft 100. For example, the ride assist system 600 may receive and process data from the speed sensor 127 and/or GNSS circuitry 126 to determine a speed of the watercraft 100 relative to the water. The filter 630 may provide calculated values such as rolling averages, accelerations derived from the speed data, or simple error checking. The filter 630 may include logic that compensates for potential errors generated by the speed sensor 127 and/or GNSS circuitry 126. As examples, the filter 630 may remove noise and outliers from the collected speed data. Speed data from the filter 630 may be used in any of the altitude controller 622, low speed controller 632, and ride quality controller 642. The ride assist system 600 may also use the location data of the GNSS circuitry 126 to determine a location of the watercraft 100. The location of the watercraft 100 may be used by the ride assist system 600 to limit operation of the watercraft 100. For example, the watercraft 100 may determine whether the watercraft 100 is within or outside of a geofenced region restrictions are placed on the operation of the watercraft 100. For example, the geofenced region may include a marina where the user is not permitted to exceed a certain speed. The ride assist system 600 may determine to be inactive and remain in the manual throttle control mode 720 (discussed below) when inside of a such a geofenced region. As another example, the ride assist system 600 may determine not to enter the flight mode until the watercraft 100 is determined to be outside of the geofenced region.

The ride assist system 600 may determine an orientation of the watercraft 100 using sensors of the watercraft 100. The ride assist system 600 may use feedback from the IMU 125 or other accelerometers and/or gyroscopes to provide pitch angles, pitch rates, and pitch accelerations of the watercraft 100. The filter 640 may provide calculated values such as rolling average and simple error checking. The filter 640 may include logic that compensates for potential errors generated by the IMU 125 and any other inertial measurement sensors. As examples, the filter 640 may remove noise and outliers from the collected data. Orientation data from the filter 640 may be used in any of the altitude controller 622, low speed controller 632, and ride quality controller 642.

The ride assist system 600 may also use input from a user interface or “trigger” on the wireless controller 130. The user input signal may pass through a filter 610 that provides a rolling average and/or simple error checking, for example if needed to eliminate spurious values. The filter 610 may output the filtered user input signal to the controllers 622, 632, and 642. In non-ride-assist modes of operation, the user input signal provides the throttle control signal to the watercraft 100 to control operation of the motor 142. In ride-assist modes of operation, the user input signal is used as an input in any of the altitude controller 622, low speed controller 632, and ride quality controller 642. For example, and as further discussed below, the user input signal may engage the ride-assist mode of operation by allowing the low speed controller 632 to calculate throttle based on the pitch angle of the board 102. In another example, and as further discussed below, the user input signal may set a desired ride height for the altitude controller 622.

Each of the altitude controller 622, low speed controller 632, and ride quality controller 642 are configured to output a value that contributes to the throttle value provided to the electronic speed controller 140 associated with the motor 142. For example, the ride assist system 600 may add the values output by the controllers 622, 632, and 642 to generate the throttle value. The user input signal received from the wireless controller 130 may also contribute to the throttle value provided to the electronic speed controller 642 along with the outputs of the controllers 622, 632, and 642, as illustrated in FIG. 6A. The controllers 622, 632, and 642 may include PID control loops, neural network-based systems, or other control systems as would be understood by persons skilled in the art.

Altitude controller 622 is configured to maintain the board 102 at a desired ride height by thrust modulation when the watercraft 100 operates in the flight mode. The altitude controller 622 modulates the throttle signal sent to the electronic speed controller 140 based on the output of filter 620, which includes an altitude signal from the ride height sensor 12. The altitude controller 622 may also receive one or more speed signals from the filter 630 and one or more pitch angle, pitch rate, and pitch acceleration signal received from the filter 640. The altitude controller compares a desired ride height (altitude) to the measured ride height (altitude) and generates a throttle output based on that comparison. The ride height of the watercraft 100 varies as a function of speed but also the pitch angle of the watercraft 100. Thus, when the board 102 has an upward pitch angle, the ride height tends to increase absent a change in the thrust output of the propulsion unit 106. And, when the board 102 has a downward pitch angle, the ride height tends to decrease absent a change in the thrust output of the propulsion unit 106. The altitude controller 622 monitors the change in ride height and automatically adjusts the thrust output of the propulsion unit 106 to maintain or achieve the desired ride height. When riders lean forward such that the board 102 has a downward pitch angle, the altitude controller will increase throttle (and consequently speed) which increases the lift of the hydrofoils 116, 117 and counters the force of the rider tilting the board 102 to a downward pitch angle. And, when riders lean backward such that the board 102 has an upward pitch angle, the altitude controller will decrease the throttle (and consequently speed) which decreases the lift of the hydrofoils 116, 117 and reduces upward pitch moment in the upward pitch 436 direction which may cause the board 102 to pitch in the downward direction under the rider's weight (when the rider does not further shift their weight). The altitude controller 622 will accordingly be perceived by the rider as a speed controller since the rider controls the center of gravity of the watercraft 100. From the rider's perspective, they lean forward on the board 102 to increase speed and lean backward on the board 102 to decrease the speed of the watercraft 100.

In the pre-flight and pre-flight abort modes of operating, the desired altitude and/or maximum throttle amplitude for the altitude controller 622 may be set so that the altitude controller is effectively inhibited/suppressed as discussed in further detail below. In other words, when the speed of the watercraft 100 is below a threshold (e.g., 9 kts), the weight of the output value of the altitude controller 622 may be reduced so that the altitude controller 622 has less of an impact (or no impact) on the throttle value provided to the electronic speed controller 140.

The altitude controller 622 may also use speed data from the filter 630. In one example, the altitude controller calculates a desired ride height based on the speed of the watercraft 100. The altitude controller may additionally determine whether the watercraft 100 is above, below, or approaching a stall speed (i.e., the speed at which the watercraft is not able to keep the board 102 in flight over the water). The stall speed may be a fixed, predetermined value or the stall speed may be calculated or observed. For example, rider weight may be calculated directly using sensors of the watercraft 100. For instance, the watercraft 100 may include sensors in the board 102 that are used to calculate the weight of the rider. The board 102 may include weight or pressure sensors (e.g., strain gauges) that estimate the weight of the rider. As another example, the board 102 may include sensors that detect how far the board 102 sinks in the water when the rider is supported by the board 102 and the watercraft 100 is not in operation. The ride assist system may enter a calibration mode where the watercraft 100 calculates the weight of the rider to adjust the controllers 622, 632, 642 of the ride assist system 600. The rider weight may be calculated indirectly by observing performance of the watercraft 100 during operation. The stall speed may also be observed and/or calculated based on the speed at which the board 102 lifts out of the water and gains altitude.

The low speed thrust controller 632 controls the watercraft 100 by modulating thrust at displacement and planing speeds using the pitch of the board 102 as input. Filter 640 outputs pitch angle data into the low speed controller 632 to enable the rider to accelerate or decelerate using the board pitch and pitch motion, as discussed below.

The ride quality controller 642 may smooth the ride of the watercraft 100 and reduce rapid changes in the ride height of the board 102. The ride quality controller 642 may receive orientation data from an orientation sensor, such as the IMU 125, and derive orientation behavior of the watercraft 100 from the orientation data. For example, the ride quality controller 642 may receive pitch angle, pitch rate, and/or pitch acceleration data from the IMU 125 through filter 640. The ride quality controller 642 aids to keep the pitch rate (change in pitch) and pitch acceleration (change in pitch rate) minimal or at zero, e.g., to dampen out quick pitch motion (e.g., caused by ride weight shifting and/or changes in the thrust of the propulsion unit 106) and the effect of such quick pitch motion on the ride height of the board 102.

The ride quality controller 642 outputs a throttle value (positive or negative value) that is summed with the output values of the low speed controller 632 and/or altitude controller 622. The throttle value adjusts the throttle command output to the electronic speed controller 140 and thus the thrust generated by the propulsion unit 106 to aid the altitude controller 622 in maintaining and achieving the target ride height by proactively countering the effect of a change in pitch of the watercraft 100 on ride height. For example, an increase in the upward pitch of the board 102 may increase the ride height of the board 102. Monitoring the pitch angle of the board 102 permits the ride assist system 600 to effectively anticipate changes in ride height due to the change in pitch. The ride quality controller 642 may reduce or amplify the thrust of the propulsion system responsive to the orientation behavior (e.g., pitch rate or pitch acceleration) to prevent sudden changes in ride height due to changes in the pitch of the board 102. The ride quality controller 642 may adjust the thrust proportional to a change in the pitch rate and/or pitch acceleration.

For example, where the upward pitch of the board 102 increases, the ride quality controller 642 may reduce the thrust (e.g., by outputting a negative throttle value) proportional to the pitch rate. Reducing the thrust as the upward pitch angle increases reduces the upward pitch moment caused by the propulsion unit 106 that counters the increase in pitch angle caused by weight shift of the rider. Reducing the thrust as the upward pitch angle increases also slows the watercraft 100 which reduces the lift 422 of the hydrofoils 116, 117 and thus limits or inhibits the increase in ride height due to the increased upward pitch angle of the board 102. Where the upward pitch of the board 102 decreases, the ride quality controller 642 may amplify or increase the thrust (e.g., by outputting a positive throttle value) proportional to the pitch rate. Increasing the thrust as the upward pitch angle increases results in a greater upward pitch moment caused by the propulsion unit 106 which counters the decrease in pitch angle caused by the weight shift of the rider. Increasing the thrust as the upward pitch angle increases also increases the speed of the watercraft 100 and thus the lift 422 of the hydrofoils 116, 117 to limit or inhibit the decrease in ride height due to the decreased upward pitch angle of the board 102. By adjusting the thrust proportional to the pitch rate, the ride quality controller 642 minimizes the sudden effect on ride height caused by a change in pitch of the board.

The contribution of the output of the ride quality controller 642 on the total throttle value may also be effectively inhibited/suppressed at low speeds as discussed in further detail below.

The ride quality controller 642 of the ride assist system 600 may be used in any mode of operation to limit sudden changes in ride height. For example, the ride quality controller 642 may output throttle signals to smooth the ride of the watercraft 100 when the watercraft 100 is operating in the manual throttle control mode 720 (discussed below) where the rider controls the throttle of the watercraft 100 with the user input mechanism of the wireless controller 130. In other words, the ride quality controller 642 may adjust the thrust of the propulsion unit 106 in any mode of operation based on the orientation behavior (e.g., pitch rate, pitch acceleration) of the board 102 to resist or counter sudden changes in the pitch of the board 102 and the ride height of the board 102.

Although FIG. 6A illustrates a summation of throttle signals, other mathematical operations could be used. For example, the summation could be replaced by logic that passes through one or more throttle signals based on the operating mode of the watercraft 100. Logic to enable or disable the respective controllers 622, 632, and 642 may also reside within the respective controllers such that only one controller outputs a throttle signals at a time.

As discussed above, both the altitude controller 622 and the low-speed controller 632 control the pitch and ride height of the board 102 because the strut 114 acts as a lever arm between the thrust force generated by the propulsion unit 106 and the center of gravity 410. Thus, changing thrust has two effects: (1) a change in accelerating/decelerating linear force in the longitudinal direction of the board, and (2) a change in pitch moment around the center of gravity.

With respect to FIG. 6B, the watercraft 100 with the ride assist system 600 may be operable through various modes. The watercraft 100 may start in a disabled mode where the watercraft 100 does not operate in response to throttle control signals of the wireless controller 130 or ride assist system 600. The user may enable the watercraft 100 to begin operation as discussed above.

Once enabled, the watercraft 100 may enter a manual throttle control mode 720 where the user is able to control the watercraft 100 in a non-ride assist mode or partially assisted mode (e.g., the ride quality controller 642 may be actively adjusting thrust as discussed above) using the wireless controller 130 to control the watercraft 100. Operation of the watercraft 100 in a non-ride assist mode may be desirable, for example, when navigating the watercraft 100 through a marina. The user may operate the watercraft 100 in the manual throttle control mode 720 until the user is ready to activate the ride assist mode. In one example, the watercraft 100 may be operated without the ride assist system when the wireless controller 130 outputs lower user input values and the ride assist system 600 may be activated when the watercraft 100 receives high user input values from the wireless controller 130. For instance, if the wireless controller 130 outputs at a user input value that is less than or equal to 97%, then the throttle variable T in the of the watercraft 100 is equal to the user input value of the wireless controller 130 and the ride assist system 600 remains inactive. When the wireless controller 130 outputs at a user input value that is greater than 97%, then the ride assist system 600 becomes active. In other forms, the user may select a button or a series of buttons on the wireless controller 130 and/or watercraft 100 to activate the ride assist system 600.

Upon receiving an indication the user would like to activate the ride assist mode, the watercraft 100 may enter the pitch control mode 730. In some forms, the watercraft 100 may be configured to enter the pitch control mode 730 directly from the disabled mode 710 upon the user enabling the watercraft 100 as described above. For example, the watercraft 100 may not include a manual throttle control mode 720 and/or may be operable without wireless controller 130. The pitch control mode 730 is active at low speeds, with the watercraft 100 being controlled primarily by the low speed controller 632 using pitch as discussed above. The throttle T output by the low speed controller 632 may be based on the pitch angle of the board 102, for example, according to the following formula:

Tᵢ₊₁=Tᵢ+k*(10°−pitchAngle)*dt

The throttle value T may be constrained to be within 0% to 95% of maximum throttle. In the above formula, the constant k is chosen to give a “smooth” ramping up/down of throttle. The value dt (seconds) is the control loop period, and the pitchAngle is the value fed from filter 640 into the low speed controller 632 (see FIG. 6A). As will be understood from the above formula, if the rider maintains the pitch angle of the board at a value less than 10 degrees of upward pitch the watercraft 100 will receive an increasing throttle command. Alternatively, if the rider maintains the pitch angle of the board at a value greater than 10 degrees of upward pitch the watercraft 100 will receive a decreasing throttle command. In other forms, a pitch angle other than 10 degrees may be used. As the speed of the watercraft 100 increases, the output of the altitude controller 622 may increasingly affect the throttle T as discussed above.

As the speed of the watercraft 100 increases, the watercraft 100 may transition from the pitch control mode 730 to the flight mode or speed-based altitude control mode 740. Once fully in the speed-based altitude control mode 740, the throttle output is controlled by the altitude controller 622 and ride quality controller 642. To ensure a smooth transition, when transitioning from the pitch control mode 730 to the speed-based altitude control mode 740 as the speed of the watercraft increases, the ride assist system 600 may gradually increase the weight given to the throttle values output by the altitude controller 622 and ride quality controller 642 and may gradually decrease the weight given to the low speed controller 632.

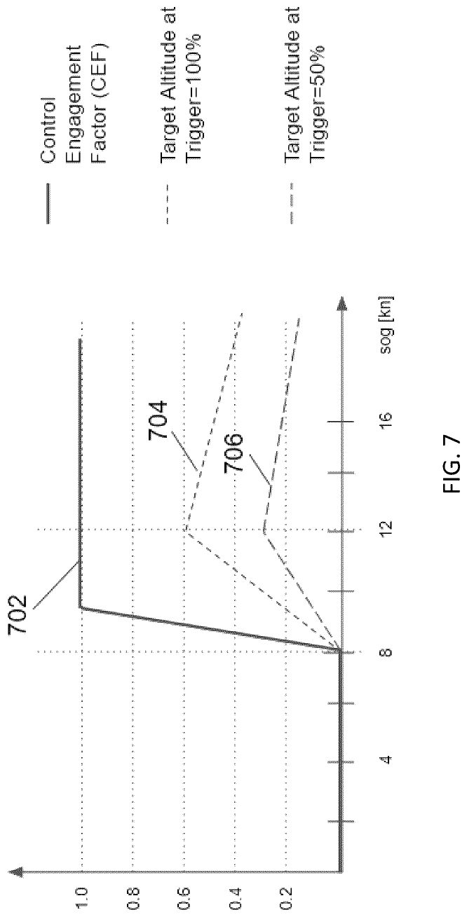

FIG. 7 shows a plot illustrating the effect of speed on the control of the ride assist system 600. As discussed above, the low speed controller 632 controls the operation of the watercraft 100 based on the pitch of the board 102 when the watercraft 100 is in the pitch control mode 730. As the speed of the watercraft 100 increases, the watercraft 100 transitions to the speed-based altitude control mode 740 where the altitude controller 622 takes over and controls the ride height of the board 102. As the speed of the watercraft 100 changes during operation, the ride assist system 600 transitions between the low speed controller 632 controlling the throttle and the altitude controller 622 controlling the throttle. Line 702 shows a control engagement factor (CEF) of altitude controller 622 on the throttle as the speed of the watercraft 100 changes. Line 702 may also be the CEF of the ride quality controller 642 on the throttle as the speed of the watercraft 100 changes.

As illustrated by line 702, once the speed of the watercraft 100 is great enough to cause the board 102 to lift away from the surface of the water (transitioning to the flight mode), the ride assist system 600 begins to increase the CEF of altitude controller 622 or, in other words, the weight given to the output of the altitude controller 622 on the throttle signal provided to the electronic speed controller 140 to achieve or maintain a target ride height for the watercraft 100. The output of the altitude controller 622 is scaled by (by being multiplied by) the CEF. The CEF is set to zero while the board 102 of the watercraft 100 is planing and the watercraft 100 is operating in the pitch control mode 730. Thus, at low speeds, the altitude controller 622 cannot affect thrust because CEF=0 and does not allow the altitude controller 622 any authority. When the watercraft 100 is transitioning to a flight mode (e.g., based on the speed of the watercraft 100), CEF is increased up to a maximum value of 1. At transitional speeds between the planing and flight modes, for example between 8 and 10 knots as shown in FIG. 7, the value of CEF is calculated based on a constant slope running from 0 to 1. The transitional values of CEF smooth the transition as the altitude controller 622 is given greater weight in controlling the throttle of the watercraft 100. The CEF of the low speed controller 632 may be the inverse of the CEF of the altitude controller 622 such that in the displacement/planing mode the CEF of the low speed controller 632 is 1 and as the watercraft transitions to the flight mode the CEF of the low speed controller 632 is transitioned to 0. The authority or weight given to throttle output signals of the ride quality controller 642 may similarly be governed by a CEF, such as that of line 702.

While the above discussion primarily describes the transition from the pitch control mode 730 to the speed-based altitude control mode 740 based on speed, in other forms, the transition may additionally or alternatively be based on the measured ride height of the board 102. For example, upon detecting the board 102 has lifted out of the water (e.g., via the ride height sensor 12), the ride assist system 600 may begin giving weight (e.g., increasing the CEF) to the output of the altitude controller 622. The weight given to the output of the altitude controller 622 may be gradually increased until the board 102 is a predetermined distance above the surface of the water, for example, 6 inches.

The altitude controller 622 seeks to achieve and maintain the board 102 at a target altitude which may be dependent on the speed of the watercraft 100. For example, the target altitude may progressively increase as the board 102 lifts out of the water toward the desired ride height in the flight mode. In some forms, once in the flight mode, the target altitude of the board 102 may decrease as the speed of the watercraft 100 increases.

In some forms, the watercraft 100 may transition directly from the manual throttle control mode 720 to the speed-based altitude control mode 740. This may occur, for example, where the user manually increases the speed of the watercraft 100 with the wireless controller 130 without the user input signal of the wireless controller 130 exceeding 97%. As another example, the watercraft 100 may not include a pitch control mode 730 such that the watercraft 100 is operated manually up to a certain speed or to a flight mode where the watercraft transitions to the speed-based altitude control mode 740. The watercraft 100 may transition from the manual throttle control mode 720 to the speed-based altitude control mode 740 as described above with respect to the transition from the pitch control mode 730 to the speed-based altitude control mode 740. For instance, the CEF or weight given to the altitude controller 622 on the throttle signal sent to the electronic speed controller 140 may to increase based on the speed or height of the board 102.

In some forms, the watercraft 100 may further include a user input-based altitude control mode 750. In the user input-based altitude control mode 750, the target altitude of the board 102 may be dependent on the user input value received from the wireless controller 130 such that the rider may control the ride height of the board 102 using the user input mechanism of the wireless controller 130. For instance, when the watercraft 100 has transitioned to the speed-based altitude control mode 740, the user may then use the user input mechanism of the wireless controller 130 to control the target altitude. The operator uses the wireless controller 130 to provide a user input to the control loop (e.g., to filter 610) of the ride assist system 600. The user input is the signal from the wireless controller 130, expressed as a percentage of full scale, that provides operator input to control the thrust of the watercraft 100 when operated in non-ride assist mode. As discussed above, the wireless controller 130 may include a thumbwheel, trigger, or other input mechanism to provide the user input value. The rider may adjust the position of the user input mechanism to send a signal in the range of 0-100%. When the watercraft 100 is controlled in the ride assist mode, the user input signal may be used to control the ride height. For example, where the user input signal from the wireless controller 130 is 100%, the target ride height of the board 102 may follow line 704 as the speed of the watercraft 100 changes. Where the user input signal from the wireless controller 130 is 50%, the target ride height of the board 102 may follow line 706 as the speed of the watercraft 100 changes.

Additionally or alternatively, the target ride height of the board 102 when in the flight mode may be controlled according to other approaches. In one approach, the user may use sudden changes in the pitch of the board 102 to indicate a desire to increase or decrease the desired ride height. For example, the user may use the pitch of the board 102 to gesture that they would like to adjust the desired ride height of the board 102. Where the user seeks to adjust their desired ride height, the user may quickly (e.g., within one second) pitch the nose portion 102A of the board 102 upward (e.g., 10 or more degrees) and return to a substantially level pitch. The ride assist system 600 may use the IMU 125 to detect that the user has flicked the nose of the board 102 upward and increase the target ride height of the board 102. To lower the ride height, the user may similarly pitch the nose downward briefly (e.g., a sudden movement of 10 or more degrees) and return to a substantially level pitch. The ride assist system 600 may use the IMU 125 to detect the user has flicked the nose of the board 102 downward and decrease the target ride height of the board 102.

In one approach the target ride height of the board 102 is set based on a sea state of the body of water in which the watercraft 100 is operating. For example, the watercraft 100 may receive weather data via the communication circuitry 124 from a remote computer. The ride assist system 600 may adjust the target ride height based on the weather data. As examples, the ride assist system 600 may adjust the ride height based on the height of the waves, chop, wind direction relative to the direction of the watercraft 100, and wind speed. For instance, the ride assist system 600 may set the target ride height at a higher altitude when taller waves are present than when shorter waves are present, e.g., to keep the board 102 above the waves during flight mode.

The watercraft 100 may transition back to the pitch control mode 730 from the speed-based altitude control mode 740 and/or user input-based control mode 750 once the speed of the watercraft 100 as the speed of the watercraft 100 slows and the board 102 transitions to the planing mode from the flight mode. Where the watercraft 100 slows abruptly (e.g., when a rider falls off the board 102) or a control signal is not received for a period of time, the watercraft 100 may transition from any of the modes back to the watercraft disabled mode 710 until the rider enables the watercraft 100 to being operation again.

The watercraft 100 may further include an alert system to notify the user when they are leaning too far forward. The alert system may include a speaker to sound an audible alarm (e.g., a beep, prerecorded message) and/or indicator lights to notify the user to lean back and increase the upward pitch of the board 102. As mentioned above, the user may lean forward on the board 102 to tip the nose of the board 102 downward to increase the speed of the watercraft 100 in the pitch control mode 730 and the speed-based altitude control mode 740. Responsive to the user pitching the nose of the board 102 downward, the ride assist system 600 may increase the throttle (e.g., the speed of the motor 142 of the propulsion unit 106) which applies a torque about the center of gravity 410 counter to the user's forward lean on the board 102 to automatically maintain balanced operation of the watercraft 100. In some situations, however, the propulsion unit 106 may not be able to generate a thrust sufficient to counter the user's forward lean. For example, when the watercraft 100 is approaching its maximum speed, the propulsion unit 106 may not be able to increase the speed of the motor 142 any further or enough to generate a thrust sufficient to counter the user's forward lean. Or, even at speeds below the maximum speed, the user may be leaning too far forward for the thrust of the propulsion unit 106 to counter the user's forward lean. If the user's forward lean is left uncorrected, the ride height of the board 102 may continue to decrease until the board 102 hits the surface of the water, which may cause the user to lose their balance and fall of the board 102. When the watercraft 100 detects that the propulsion unit 106 will not be able to generate thrust sufficient to counter the user's lean, the watercraft may notify the user via the alert system to lean back on the board 102.

To determine when to sound the alarm, the ride assist system 600 may monitor a balancing margin of the watercraft 100. The watercraft may have a present thrust of the propulsion unit 106 and a maximum operating thrust of the propulsion unit 106. The balancing margin may be determined by the difference between the maximum operating thrust and the present thrust of the watercraft. The ride assist system 600 monitors the balancing margin over time and when the balancing margin falls below a threshold, the ride assist system 600 may cause the alarm system of the watercraft 100 to generate an alarm to warn the user they are leaning too far forward and to lean back.

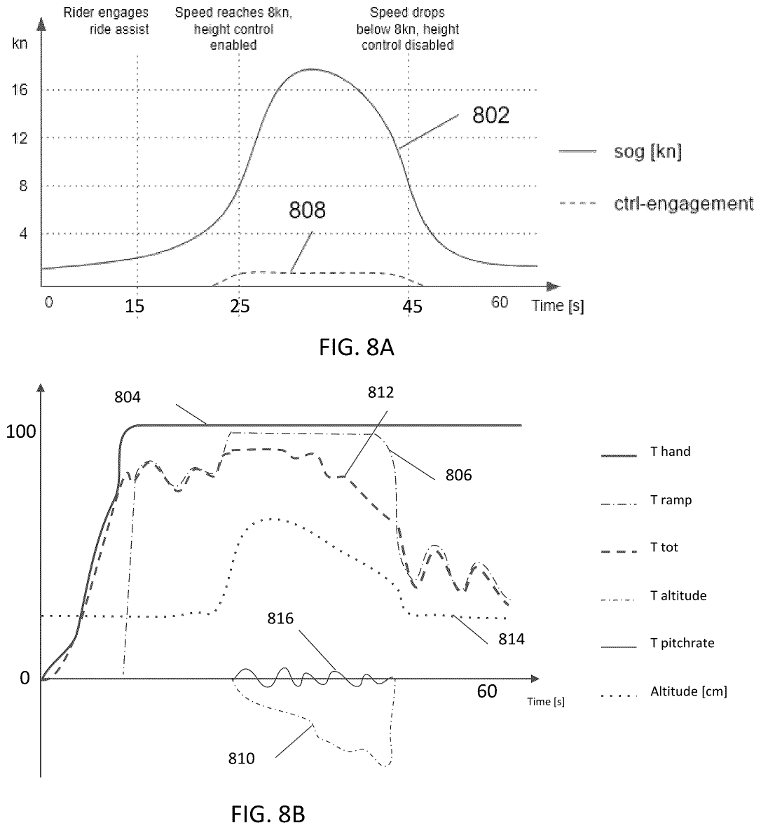

FIGS. 8A and 8B illustrate example plots of the watercraft 100 with the ride assist system 600 during operation. The ordinate (y-axis) of FIG. 8A shows speed over ground of the watercraft 100 in knots. The abscissa (x-axis) of FIG. 8A shows time in a range from approximately 0 seconds to 60 seconds during operation of the watercraft 100. FIG. 8A includes curve 802 representative of the speed of the watercraft 100 during operation. The ordinate (y-axis) of FIG. 8B shows percentages of a maximum and altitude in centimeters. The abscissa (x-axis) of FIG. 8B shows time from approximately 0 seconds to 60 seconds during operation of the watercraft 100. FIGS. 8A and 8B illustrate the same time period such that data from FIG. 8A corresponds to data in FIG. 8B and vice-versa. FIG. 8B shows various curves of various throttle signal T variables and the altitude of the board 102 of the watercraft 100 over time.

As illustrated by the T_{hand} curve 804 in FIG. 8B, the watercraft 100 is operated in the manual throttle control mode 720 where the rider uses the wireless controller 130 to manually control the throttle until t≈15 s. After t≈15 s the user input signal from the wireless controller 130 is greater than 97%, causing the watercraft 100 to transition to the pitch control mode 730 and enabling the low speed controller 632 to begin outputting a throttle value based on the pitch angle of the board 102. The watercraft accordingly enters a “pre-flight mode” as has been discussed above.

The output curve 806 of the low speed controller 632 is labeled in FIG. 8B as Tᵣₐₘₚ, which increases from t≈15-25 s (albeit with some “wabbles” due to pitch angle wobbling). The speed of the watercraft 100 correspondingly begins to increase, as shown in the watercraft speed curve 802 in FIG. 8A.

At t≈25 s the speed of the watercraft 100 is high enough so that the CEF of the altitude controller 622 begins ramping from 0 to 1 as indicated by curve 808 in FIG. 8A, transitioning to the speed-based altitude control mode 740. As shown, the output of the altitude controller 622 gradually increases, which can be seen in the T_{altitude} curve 810 illustrated in FIG. 8B. As shown in the example graph of FIG. 8B, T_{altitude} supplies negative throttle values, effectively decreasing the total throttle Tₜₒₜ curve 812, which was equivalent to Tᵣₐₘₚ at times before t≈25 s when the CEF began increasing. As discussed above, the amount of thrust required to maintain speed in the flight mode is typically less than the amount of thrust required in the pre-flight modes. Thus, even though speed of the watercraft 100 continues to increase after t≈25 s, less throttle is needed. The throttle signals output by the altitude controller 622 and the low speed controller 632 serve to maintain a relatively constant altitude as shown in the altitude [cm] curve 814 between t≈25-45 s.

In addition to the altitude controller 622, when CEF begins ramping from 0 to 1 at t≈25 s the ride quality controller 642 also begins outputting rate-dampening throttle signals represented by the T_{pitchrate} curve 816. Along with Tᵣₐₘₚ and T_{altitude}, the rate-damping throttle signals T_{pitchrate} (and, in some cases, pitch acceleration-based throttle signals) are summed to create Tₜₒₜ. The value of T_{pitchrate} is small relative to T_{altitude} and Tᵣₐₘₚ.

Between t≈15-45 s the rider controls the speed of watercraft 100 using weight shift relative to the center of gravity 410 of the watercraft 100, and the ride assist system 600 maintains altitude by adjusting the throttle control signal sent to the electronic speed controller 140 of the propulsion unit 106.

As illustrated in FIG. 8A, at t≈45 s the speed of the watercraft 100 slows to a speed low enough that CEF decreases from 1 toward 0 as indicated by curve 808, and the watercraft 100 transitions back to the pitch control mode 730. The throttle signals T_{altitude} and T_{pitchrate} plotted in FIG. 8B are constrained and arrive at a zero value when CEF arrives at 0. Hence the contributions of the T_{altitude} and T_{pitchrate} to the total throttle Tₜₒₜ diminish as the CEF tends toward 0. Since trigger is still >97% the ride assist system 600 remains active, the watercraft 100 transitions to the pitch control mode 730 with the low speed controller 632 providing the throttle signal Tᵣₐₘₚ (which is now the same as Tₜₒₜ), again “wobbly” because the board 102 is rocking slightly during operation. The speed of the watercraft 100 drops to approximately 2 knots, corresponding to the rider “taxiing” to a dock.

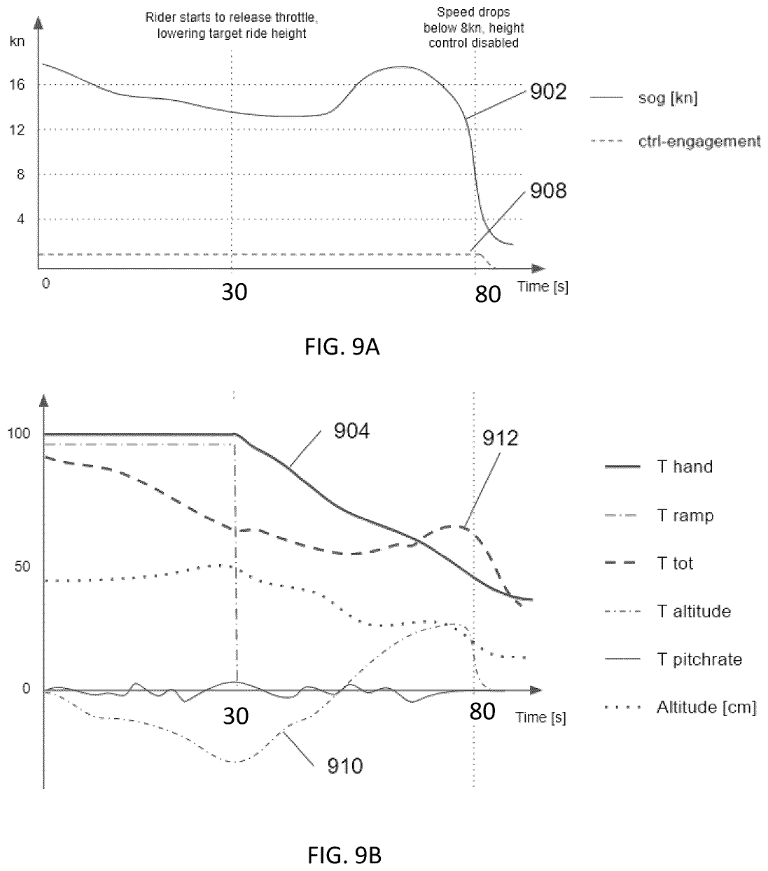

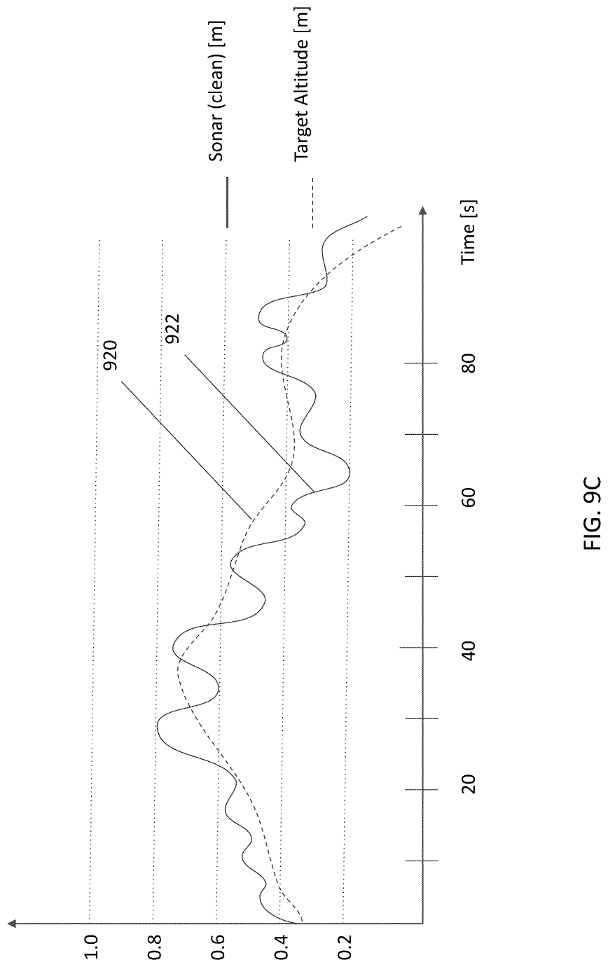

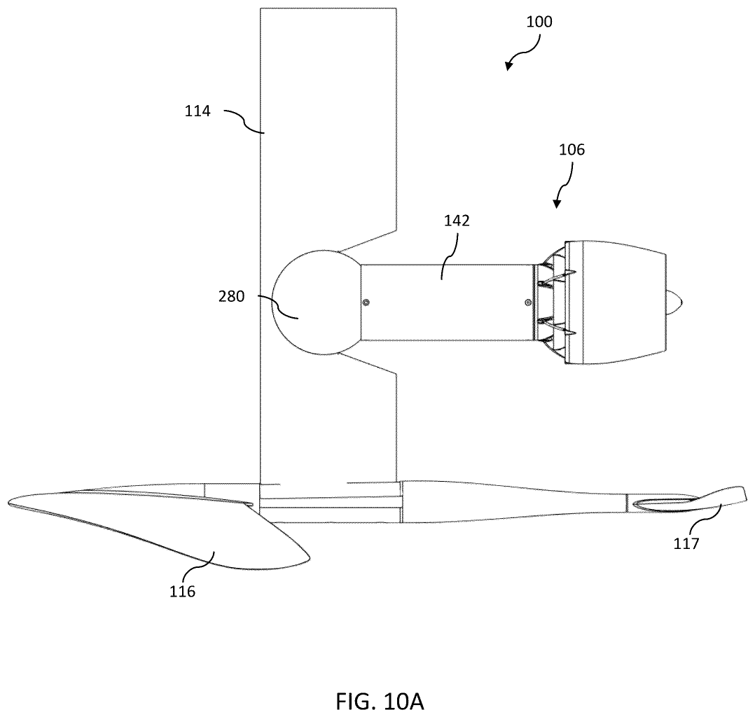

FIGS. 9A-9C illustrate plots of the watercraft 100 with the ride assist system 600 during operation according to another example where the watercraft 100 transitions from the speed-based altitude control mode 740 to the user input based altitude control mode 750 where the user input mechanism (e.g., a trigger or thumbwheel) of the wireless controller 130 is used to control the desired ride height of the watercraft 100, as discussed further below.

The ordinate (y-axis) of FIG. 9A shows speed over ground of the watercraft 100 in knots. The abscissa (x-axis) of FIG. 9A shows time in a range from approximately 0 seconds to 100 seconds during operation of the watercraft 100. The ordinate (y-axis) of FIG. 9B shows throttle values as a percentage of maximum, and altitude in centimeters. The abscissa (x-axis) of FIG. 9B shows time in the same range from approximately 0 seconds to 100 seconds during operation of the watercraft 100. The ordinate (y-axis) of FIG. 9C shows altitude in meters. The abscissa (x-axis) of FIG. 9A shows time in a range from approximately 0 seconds to 100 seconds during operation of the watercraft 100. FIGS. 9A-9C illustrate the same time period such that data from FIG. 9A corresponds to data in FIGS. 9B and 9C and vice-versa.

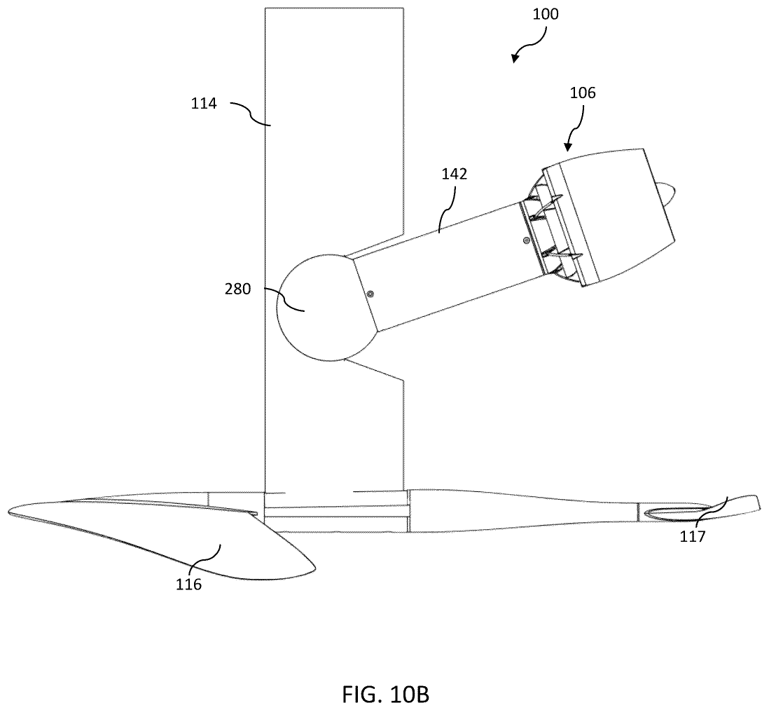

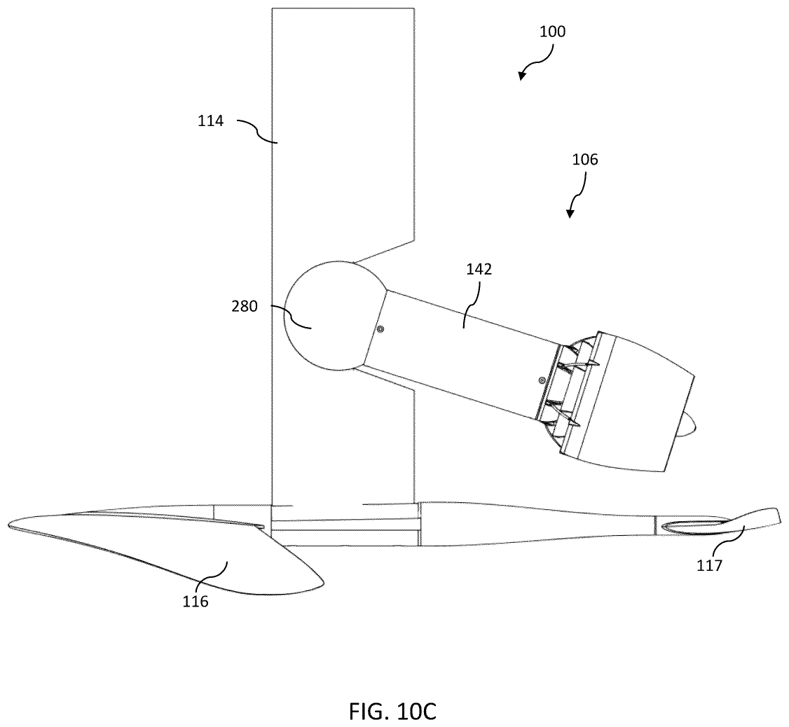

At times below t≈30 s the watercraft 100 is in a flight mode (e.g., the board 102 is lifted out of the water) and operates in the speed-based altitude control mode 740 using a speed-based altitude control mode (see 740 in FIG. 10) where the throttle is controlled based on the throttle outputs of the altitude controller 622 and the ride quality controller 642. The rider maintains user input values from the wireless controller 130 greater than 97%, as illustrated by values plotted for the T_{hand} curve 904. Because the watercraft 100 is in speed-based altitude control mode 740, the altitude controller 622 uses a calculated target altitude based on the speed of the watercraft 100. Before t≈30 s the target altitude (Alt_{target}) curve 920 plotted in FIG. 9C varies inversely with the speed plotted in FIG. 9A.

At t≈30 s, the rider eases off the user input mechanism of the wireless controller 130 as shown by the plot of the T_{hand} curve 904 in FIG. 9B, indicating the rider desires to lower the target altitude of the watercraft 100 and transitioning to the user input based altitude control mode 750. The target altitude (Alt_{target}) plotted in FIG. 9C varies correspondingly to the values of the T_{hand} curve 904 plotted in FIG. 9B. The speed of the watercraft 100 decreases slightly between t≈30-50 s, but the T_{altitude} signal (plotted as the T_{altitude} curve 910) output from the altitude controller 622 increases as the watercraft 100 slows, to bring and maintain the board 102 to the new lower desired altitude. The increase in T_{altitude} causes an increase in the Tₜₒₜ value (plotted as Tₜₒₜ curve 912) and increase in the speed of the watercraft 100 at t≈50 s.

At t≈80 s the value of T_{hand} is small enough such that the target ride height is low enough to land the board 102 on the water. As the board 102 lands on the water, the speed of the watercraft 100, plotted as curve 902, decreases rapidly. With the decrease in speed, the CEF signal, plotted as curve 908 in FIG. 9A, accordingly drops from 1 to 0, which reduces the weight the throttle signal T_{altitude} generated by the altitude controller 622 and signals T_{pitchrate} and T_{pitchacc} generated by the ride quality controller 632 have on the throttle signal Tₜₒₜ provided to the propulsion unit 106.

FIG. 9C further illustrates the measured altitude of the board 102, plotted as curve 922, calculated based on the data output from ride height sensor 12. As shown, the altitude of the board 102 corresponds closely to the target altitude as the target altitude changes over time based. This is due to the ride assist system 600 adjusting the throttle control of the watercraft 100 as discussed above.

With respect to FIGS. 10A-10C, the propulsion unit 106 is shown mounted to the strut 114 of the watercraft 100 by an attachment mechanism 280 permitting the propulsion unit 106 to be pivoted relative to the strut 114. By mounting the propulsion unit 106 to the strut 114 by way of a pivoting attachment mechanism 280, the direction of thrust provided by the propulsion unit 106 relative to the watercraft 100 may be adjusted. The attachment mechanism 280 may include a ball joint positioned between the strut 114 and the front end of the motor 142 of the propulsion unit 106. A servo motor control mechanism may be attached to the propulsion unit 106 and the strut 114 and configured to pivot the propulsion unit 106 about the attachment mechanism 280 in all directions, e.g., up, down, left, and/or right. The ride assist system 600 may be configured to change the direction of the thrust of the propulsion unit 106 by pivoting the propulsion unit 106 relative to the strut 114. By pivoting the direction of the thrust vector produced by the propulsion unit 106, the propulsion unit 106 may be used to control the operation of the watercraft 100, for instance, by adjusting or maintaining the ride height of the watercraft 100 and/or aiding in turning the watercraft 100. For example, the ride assist system 600 may pivot the propulsion unit 106 downward as shown in FIG. 10C to increase the upward component of the thrust vector of the propulsion unit 106 to aid in raising the altitude of the board 102. The ride assist system 600 may pivot the propulsion unit 106 upward as shown in FIG. 10B to increase the downward component of the thrust vector of the propulsion unit 106 to aid in lowering the altitude of the board 102. The ride assist system 600 may additionally adjust the speed of the motor 142 along with changing the orientation of the propulsion unit 106 to achieve and maintain a target ride height.

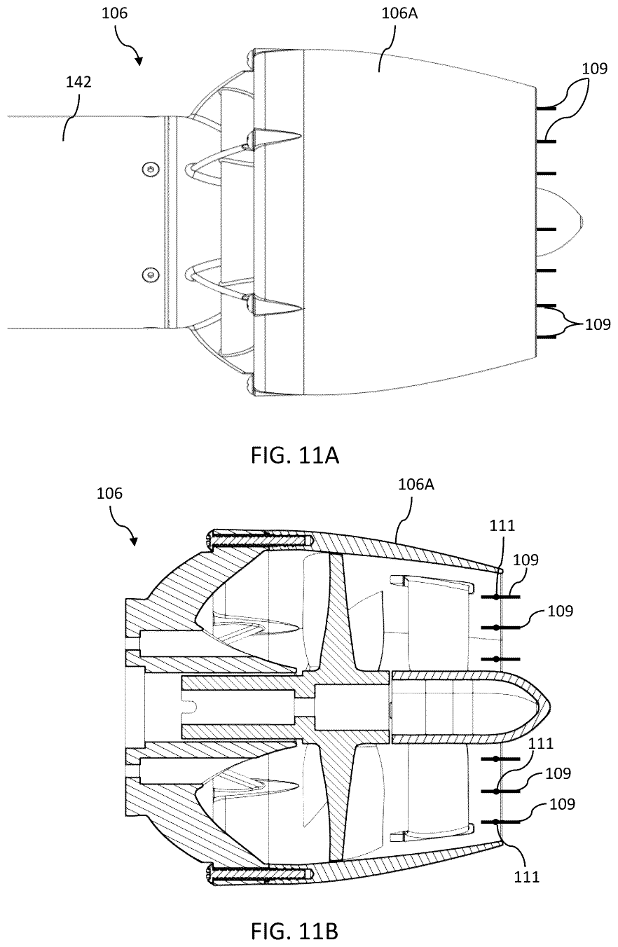

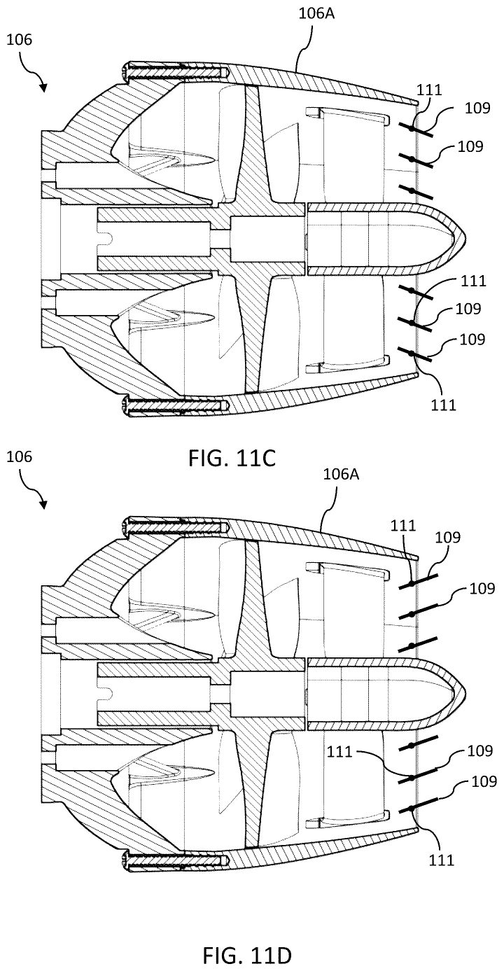

With respect to FIGS. 11A-11D, a housing 106A of the propulsion unit 106 may additionally or alternatively include one or more vanes 109 to direct the flow of fluid out of the propulsion unit 106. The vanes 109 may be movably mounted to the housing 106A. For example, the vanes 109 may be pivotably mounted to the housing 106A via a shaft 111. An actuator (e.g., a motor) may be operably coupled to the vanes 109 and configured to move the vanes 109 to change the direction of the flow of fluid out of the propulsion unit. For example, the actuator may pivot the shafts 111 to which the vanes 109 are mounted to change the direction of flow out of the propulsion unit 106. Redirecting the flow of the fluid using the vanes 109 changes the thrust vector of the propulsion unit 106. With respect to FIGS. 11A-11B, the vanes 109 are straight such that the thrust vector is aligned with the propulsion unit 106. With respect to FIG. 11C, the vanes 109 are tilted downward to direct the flow of fluid downward as it exits the housing 106A which causes the thrust vector of the propulsion unit 106 to have an upward or lifting component (e.g., to raise the ride height of the watercraft 100). With respect to FIG. 11D, the vanes 109 are tilted upward to direct the flow of fluid upward as it exits the housing 106A which causes the thrust vector of the propulsion unit 106 to have a downward component (e.g., to lower the ride height of the watercraft 100).

The propulsion unit 106 may be used to control the operation of the watercraft 100, for instance, by adjusting or maintaining the ride height of the watercraft 100. For example, the ride assist system 600 may pivot the vanes 109 propulsion unit 106 downward as shown in FIG. 11C to increase the upward component of the thrust vector of the propulsion unit 106 to aid in raising the altitude of the board 102. The ride assist system 600 may pivot the vanes 109 of the propulsion unit 106 upward as shown in FIG. 11B to increase the downward component of the thrust vector of the propulsion unit 106 to aid in lowering the altitude of the board 102. The ride assist system 600 may additionally adjust the speed of the motor 142 along with changing the orientation of the propulsion unit 106 to achieve and maintain a target ride height.

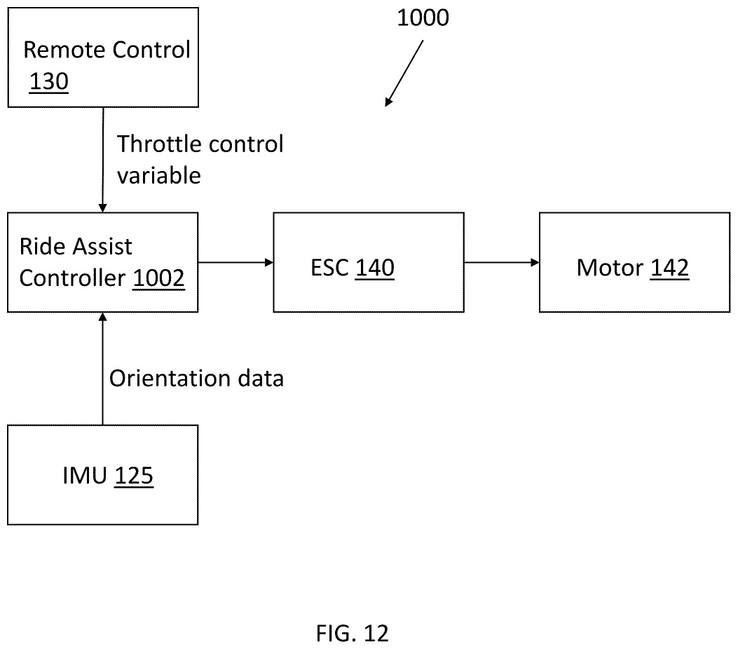

With respect to FIG. 12, a ride assist system 1000 for the watercraft 100 is provided according to another embodiment. In this embodiment, the rider controls the throttle of the watercraft 100 using the throttle 132 of the wireless remote controller 130 and a ride assist controller 1002 of the watercraft 100 makes adjustments to the throttle signal sent to the propulsion system 106 of the watercraft 100 based on the orientation (e.g., pitch, roll) of the board 102. In other words, the rider 101 controls the watercraft as they normally would without ride assist (e.g., using the throttle 132 and weight shift) and the ride assist controller 1002 makes adjustments to the throttle signal sent to the ESC 140, for example, to stabilize the board 102.

The ride assist controller 1002 may be the processor 120 executing computer readable instructions stored in memory 122 to adjust the throttle control variable as discussed herein. The ride assist controller 1002 receives a throttle control variable from the remote controller 130. For instance, a rider may engage the throttle 132 (e.g., trigger or thumbwheel) of the remote controller 130 to cause the remote controller 130 to send a throttle control variable to the watercraft 100. The ride assist controller 1002 may receive the throttle control variable from the remote controller 130 via the communication circuitry 124.

The ride assist controller 1002 receives orientation data from the IMU 125. The ride assist controller 1002 may analyze the orientation data to determine an orientation behavior of the watercraft 100, for example, a pitch angle, pitch rate, pitch acceleration, roll angle, roll rate, roll acceleration, etc. Based on the orientation behavior of the watercraft 100, the ride assist controller 1002 may adjust the throttle control variable and output the adjusted throttle control variable to the ESC 140 to operate the motor 142.

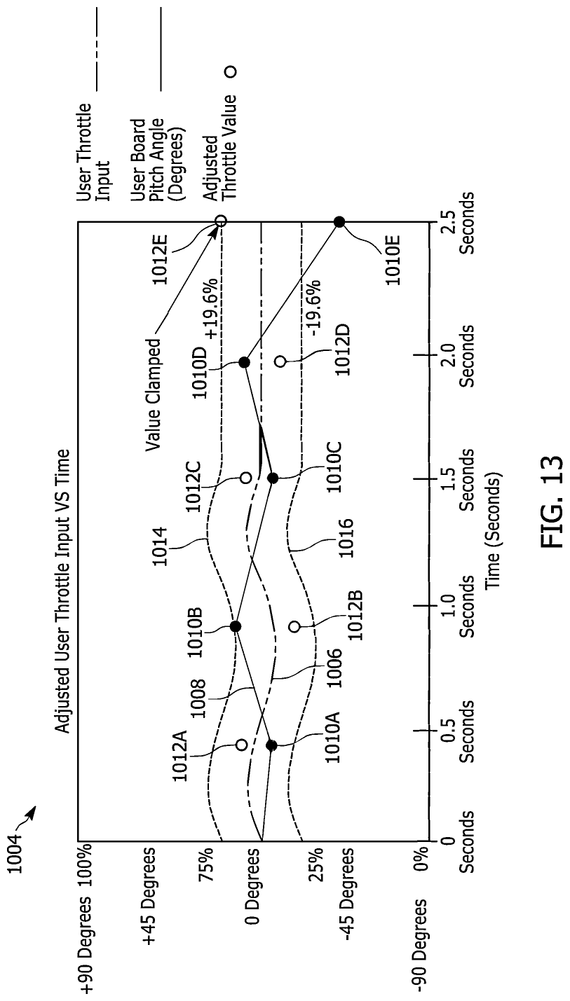

With respect to FIG. 13, an example plot 1004 is provided showing operation of the watercraft 100 with the ride assist system 1000 to make adjustments to the throttle control variable based on the pitch behavior of the board 102. The ordinate (y-axis) of FIG. 13 shows the throttle control variable as percentage of a full throttle command and pitch angle of the board 102 in degrees. The abscissa (x-axis) of FIG. 13 shows time in a range from approximately 0 seconds to 2.5 seconds during operation of the watercraft 100.

In the plot 1004, a user throttle input curve 1006 shows the throttle control variable that is input by the rider using the remote controller 130 over time. A pitch angle curve 1008 shows the pitch angle of the board 102 over time. In this example, the pitch angle is sampled periodically at points 1010A-1010E and the pitch angle curve 1008 is generated based on these data points. In this example, the pitch angle is shown as being sampled every half of a second, however, the pitch angle of the board 102 can be sampled at any sampling rate. For instance, the pitch angle can be calculated substantially continuously to generate a smooth pitch angle curve 1008. The ride assist controller 1002 can calculate the pitch rate of the board 102 based on the pitch angle points 1010A-1010E and/or curve 1008.

The ride assist controller 1002 receives the pitch angle data 1010A-1010E and adjusts the throttle control value 1012A-1012E that is output to the ESC 140 to adjust the thrust of the propulsion unit 106. The ride assist controller 1002 may increase the throttle control value to increase the thrust of the propulsion unit 106 when the board 102 has a downward or negative pitch angle. Increasing the thrust of the propulsion unit 106 increases the torque applied by the propulsion unit 106 about the center of gravity 410 of the watercraft 100 that counters the downward pitch angle of the board (e.g., due to the user's forward lean on the board 102) to aid in maintaining balanced operation of the watercraft 100. Conversely, the ride controller 1002 may decrease the throttle control value to decrease the thrust of the propulsion unit 106 when the board 102 has an upward or positive pitch angle. Decreasing the thrust of the propulsion unit 106 may decrease the upward torque applied by the propulsion unit 106 about the center of gravity 410 of the watercraft thereby reducing the upward pitch angle of the board (e.g., due to the user's rearward lean) to aid in maintaining balanced operation of the watercraft 100. The amount the ride controller 1002 adjusts the throttle control variable may be proportional to the pitch angle. For example, the greater the upward or downward pitch angle, the greater the adjustment to the throttle control value. By adjusting the throttle control variable sent to the ECU 140 to control the motor 142, the ride assist controller 1002 controls the pitch angle of the board 102 to aid in stabilizing the board 102. For instance, the ride assist controller 1002 adjusts the throttle control variable to dampen sudden changes in the pitch angle of the board 102 that may cause the rider to lose their balance and fall off of the board 102. The ride assist controller 1002 also adjusts the throttle control variable to bring the pitch angle back toward a neutral pitch angle (e.g., 0 degrees) and/or reduce changes of the pitch angle away from the neutral pitch angle.

In some forms, the ride assist controller 1002 may have limits that set the maximum amount of adjustment the ride assist controller 1002 will make to the throttle control variable based on pitch angle. In the example shown, the ride assist controller 1002 has a maximum positive throttle adjustment 1014 and a maximum negative throttle adjustment 1016. In this example, the maximum positive throttle adjustment 1014 is about 20% of the throttle control variable and the maximum negative throttle adjustment 1016 is about-20% of the throttle control variable, although other limits may be used. Where the pitch angle changes faster than a predetermined pitch rate (e.g., 45 degrees/per second), the adjustment to the throttle control variable is no longer proportional to the pitch angle but instead the adjustment is capped at the maximum negative throttle adjustment 1016 or maximum positive throttle adjustment 1014. For example, the pitch rate from pitch angle point 1010D to pitch angle point 1010E is faster than the predetermined pitch rate (e.g., more than 45 degrees/second) and thus the throttle value is adjusted by the maximum throttle adjustment value, in this case the maximum positive adjustment value because pitch angle point 1010E is a negative pitch angle. Where the pitch rate changes faster than the predetermined pitch rate and the pitch angle is positive, the maximum negative positive adjustment value is applied. Limiting the adjustment that can be made to the throttle control variable by the ride assist controller 1002 dampens the effect of the ride assist controller 1002 where there are large changes in the pitch of the board 102. Limiting the adjustment the ride assist controller 1002 makes in response to significant changes in pitch provides more gradual assistance to the rider. Responding too abruptly or aggressively, for example, may cause the rider to lose their balance.

In another form, the maximum positive throttle adjustment 1014 and a maximum negative throttle adjustment 1016 are applied when the pitch angle of the board 102 is outside of a predetermined range (e.g., −22.5 degrees to 22.5 degrees). For example, when the pitch angle of the board 102 is below the predetermined range of pitch angles (e.g., less than −22.5 degrees), the ride assist controller 1002 adjusts the throttle control variable by the maximum positive throttle adjustment 1014 value regardless of how far the pitch angle is outside of the predetermined range. Similarly, if the pitch angle is determined to be above the predetermined range of pitch angles (e.g., greater than 22.5 degrees), then the ride assist controller 1002 adjusts the throttle control variable by the maximum negative throttle adjustment 1016 value regardless of how far the pitch angle is outside of the predetermined range.

While the above example describes the ride assist controller 1002 adjusting the throttle control variable based on the pitch angle and/or pitch rate, the ride assist controller 1002 similarly could additionally or alternatively adjust the throttle control variable based on the roll behavior. For example, the ride assist controller 1002 may adjust the throttle control variable to assist the rider in turning the watercraft 100. The ride assist controller 1002 may combine the throttle adjustment based on pitch with the throttle adjustment based on the roll to determine the amount of adjustment to make to the throttle control variable.

By way of background, in a non-assisted hydrofoiling watercraft, to turn the watercraft the rider applies force to the board 102 to cause the watercraft 100 to turn and to maintain the ride height of the board 102 while maintaining their balance on the board 102. The rider may turn the watercraft 100 using a yaw-induced turn, a roll-induced turn, or a combination of both. In a yaw-induced turn, the rider twists the board 102 of the watercraft 100 about its yaw axis (e.g., vertical axis) using their hips, knees, shoulders, and/or arms which changes the heading of the watercraft 100. In a roll-induced turn, the rider shifts their weight laterally across the board 102 to cause the board 102 to roll about the longitudinal axis of the watercraft 100. For example, the rider may lean laterally relative to the board 102 and/or apply pressure with their toes or heels to cause the board 102 to roll. As the roll angle of the board 102 moves from neutral (e.g., 0 degrees), the watercraft 100 loses altitude because the vertical component of the lift force generated by the hydrofoil wings 116, 117 is reduced as the lift force has an increasing lateral (e.g., horizontal) component due to the roll angle of the watercraft 100. The greater the roll angle, the greater the reduction in vertical lift as the lateral component of the lift force increases. To counteract the reduction in lift force to maintain a constant ride height, the rider may increase the pitch angle of the board 102 (e.g., by leaning rearward on the board 102) to pitch the hydrofoil wings 116, 117 upward thereby increasing the lift of the hydrofoil wings 116, 117 and to increase a vertical component of the propulsion force generated by the propulsion system 106. To turn with a non-assisted hydrofoiling watercraft involves a delicate balancing act by the rider to cause the watercraft to roll at the desired angle for the turn and to cause the watercraft 100 to pitch at the desired angle to maintain the ride height. To cease turning, the rider reverses these steps, causing the board 102 to return to the neutral roll angle while decreasing the pitch of the board 102 to maintain the ride height of the board 102. Turning the non-assisted watercraft while remaining on the board 102 thus requires skill and/or experience.

The ride assist system 1000 may aid the user in turning the watercraft by adjusting the thrust of the propulsion system 106 when the roll angle of the board 102 changes to aid the rider in maintaining the ride height of the board 102 through the turn. The ride assist system 1000 reduces (e.g., eliminates) the pitch adjustment the rider needs to make to maintain the ride height through the turn. In the ride assist system 1000, the ride assist controller 1002 may determine the roll angle of the watercraft 100 and adjust the throttle control variable based on the roll angle. The ride assist controller 1002 may receive orientation data from the IMU 125 in real-time and determine the current roll angle of the board 102 based on the orientation data. The ride assist controller 1002 may adjust the throttle control variable based on the roll angle to maintain the ride height of the board 102. For instance, increasing the throttle control variable received from the rider causes the propulsion system 106 to generate additional thrust which increases the speed of the watercraft 100 causing the lift force generated by the hydrofoil wings 116, 117 to increase. Conversely, reducing the throttle control variable received from the rider reduces the thrust generated by the propulsion system 106 to reduce the speed of the watercraft 100 and thus the lift force generated by the hydrofoil wings 116, 117. The ride assist controller 1002 may calculate an amount of adjustment to make to the throttle control variable to compensate for the loss of lift force due to the roll angle of the board 102. In some forms, the ride assist controller 1002 may determine when the roll angle of the board 102 exceeds a predetermined threshold (e.g., 20 degrees from neutral) that indicates the rider is turning the watercraft 100. Upon determining the predetermined roll threshold has been exceeded, the ride assist controller 1002 may determine the rider is initiating a turn and begin to actively assist the rider through the turn by adjusting the throttle control variable as discussed above to maintain the ride height through the turn. Adjusting the throttle based on the roll angle aids the rider in maintaining the ride height of the board 102 through turn without also having to adjust the pitch of the board 102.

The ride assist controller 1002 may limit adjustments to the throttle control variable received from the rider. In some forms, the ride assist controller 1002 may have limits that set the maximum amount of adjustment the ride assist controller 1002 will make to the throttle control variable based on the roll angle, similar to the pitch angle discussed above. For example, the ride assist controller 1002 may have a maximum throttle adjustment to limit the amount of adjustment the ride assist controller 1002 is able to make to the throttle control variable based on the roll angle.

The ride assist controller 1002 may also limit the adjustments to the throttle control variable received from the rider based on the speed of the watercraft 100. The ride assist controller 1002 may receive and process data from the speed sensor 127 and/or GNSS circuitry 126 to determine a speed of the watercraft 100. Where the speed of the watercraft 100 is below a threshold speed, the ride assist controller 1002 may reduce the adjustment made to the throttle control variable based on the roll angle of the watercraft. In some forms, where the speed of the watercraft 100 is below a threshold speed, the ride assist controller 1002 is disabled. Where the speed of the watercraft 100 is above a threshold speed, the ride assist controller 1002 may limit the adjustment to the throttle control variable to inhibit overcompensation based on the roll angle and avoid erratic behaviors.

The ride assist controller 1002 may determine when the rider has fallen off the watercraft 100 and adjust the operation of the propulsion system 106. The ride assist controller 1002 may receive data related to the power consumption of the watercraft 100. For example, the ride assist controller 1002 may receive power data, such as a voltage and current draw, of the propulsion system 106. For instance, the ride assist controller 1002 may communicate with the intelligent power unit 128 to receive power data of the propulsion system 106. The ride assist controller 1002 may monitor the power consumption data of the propulsion system 106 for changes that indicate the rider has fallen off the board. For instance, the power consumption of the propulsion system 106 may be reduced significantly when the rider falls off the board 102 due to the reduced weight on the watercraft 100. Upon determining the rider has fallen off of the board 102, the ride assist controller 1002 may reduce the throttle control variable and/or cut power from the propulsion system 106.

The ride assist controller 1002 may be calibrated to optimize the performance of the watercraft 100. For example, the speed thresholds, throttle adjustment limits, and compensation functions may be adjusted based on the rider (e.g., weight, height, skill level, etc.), the watercraft design, and/or water conditions. For example, the ride assist controller 1002 may be calibrated based on empirical data collected from testing the watercraft 100 with various riders and at various water conditions.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

1. A watercraft comprising:
a board having a top surface and a bottom surface;
a propulsion system coupled to the bottom surface of the board such that a thrust generated by the propulsion system is configured to move the board forward through a body of water;
an orientation sensor configured to output orientation data of the board; and
a ride assist controller communicatively coupled to the orientation sensor and the propulsion system;
wherein the ride assist controller is configured to adjust the thrust generated by the propulsion system based at least in part on an orientation behavior of the board derived from the orientation data.

2. The watercraft of claim 1 further comprising:
a strut extending from the bottom surface of the board;
a hydrofoil disposed along the strut;
wherein the propulsion system is disposed along the strut.

3. The watercraft of claim 2 wherein the orientation behavior includes a pitch of the board and wherein the ride assist controller increases the thrust of the propulsion system as the pitch of the board decreases and decreases the thrust of the propulsion system as the pitch of the board increases.

4. The watercraft of claim 1 wherein the orientation behavior includes a pitch rate of the board and/or a pitch acceleration of the board derived from the orientation data, wherein to adjust the thrust of the propulsion system includes adjusting the thrust based at least in part on a pitch rate of the board or a pitch acceleration of the board.

5. The watercraft of claim 4 wherein to adjust the thrust of the propulsion system based at least in part on the pitch rate or pitch acceleration includes to dampen or amplify a change in thrust responsive to the pitch rate or pitch acceleration.

6. The watercraft of claim 1 wherein the propulsion system includes an electric motor, wherein adjusting the thrust generated by the propulsion system includes modulating electric power provided to the electric motor.

7. The watercraft of claim 1 wherein adjusting the thrust generated by the propulsion system includes adjusting a direction of thrust of the propulsion system.

8. The watercraft of claim 1 wherein the orientation behavior includes a roll behavior of the board and wherein the ride assist controller is configured to adjust the thrust of the propulsion system based at least in part on the roll behavior of the board.

9. The watercraft of claim 1 wherein the orientation sensor includes at least one of an accelerometer, gyroscope, inertial measurement unit, ultrasonic sensor, radar sensor, impedance sensor, resistive sensor, and capacitive sensor.

10. The watercraft of claim 2 further comprising:
a position sensor configured to output position data indicating a position of the watercraft relative to a surface of the body of water;
the ride assist controller communicatively coupled to the sensor and the propulsion system;
wherein the ride assist controller is configured to adjust the thrust generated by the propulsion system based at least in part on a ride-height derived from the position data.

11. The watercraft of claim 10 further comprising a processor, wherein the processor is configured to run software embodying the ride assist controller.

12. The watercraft of claim 10 wherein the ride assist controller is configured to adjust the thrust generated by the propulsion system based at least in part on the output from the position sensor to achieve a target ride height.

13. The watercraft of claim 12 further comprising a speed sensor configured to output speed data of the board, wherein the ride assist controller is communicatively coupled to the speed sensor, and wherein the target ride height is a function of a speed derived from the speed data.

14. The watercraft of claim 13 wherein when the speed is below a threshold speed, the target ride height decreases at a predefined rate until the board contacts the water.

15. The watercraft of claim 13 wherein when the speed is above a threshold speed and the board is below a desired ride height, the target ride height increases at a predefined rate.

16. The watercraft of claim 10 wherein the ride assist controller is further configured to adjust the thrust of the propulsion system based at least in part on a vertical speed and/or acceleration of the board relative to a surface of the body of water, wherein the speed and/or acceleration is derived from the position data.

17. The watercraft of claim 10 wherein the position sensor includes at least one of an ultrasonic sensor, radar sensor, pressure sensor, impedance sensor, resistive sensor, and capacitive sensor.

18. The watercraft of claim 1 further comprising a speed sensor communicatively coupled to the ride assist controller, wherein the ride assist controller is configured to adjust the thrust generated by the propulsion system based at least in part on the output from the speed sensor.

19. The watercraft of claim 2 wherein the hydrofoil includes no movable control surfaces.

20. The watercraft of claim 1 further comprising a remote controller configured to receive user input from a rider of the watercraft; wherein the ride assist controller is configured to receive an input from the remote controller enabling the ride assist controller to control operation of the propulsion system based on the orientation behavior of the board.

21-36. (canceled)

37. A hydrofoiling watercraft comprising:
a support platform having a top surface and a bottom surface;
a strut extending from the bottom surface of the support platform;
a hydrofoil disposed along the strut;
a propulsion system coupled to the strut such that a thrust generated by the propulsion system is configured to move the support platform forward through a body of water;
an orientation sensor configured to output orientation data of the support platform; and
a controller communicatively coupled to the orientation sensor and the propulsion system;
wherein the controller is configured to control the thrust of the propulsion system to position the support platform at a target height above a surface of the body of water, the controller configured to adjust the thrust based at least in part on an orientation behavior of the support platform derived from the orientation data.

38. The hydrofoiling watercraft of claim 37 wherein to adjust the thrust of the propulsion system based at least in part on the orientation behavior includes to reduce or amplify the thrust responsive to the orientation behavior.

39. The hydrofoiling watercraft of claim 38 wherein to reduce or amplify the thrust includes reducing or amplifying the thrust proportional to the orientation behavior.

40. The hydrofoiling watercraft of claim 37 wherein the orientation behavior includes a pitch rate of the support platform derived from the orientation data, wherein to adjust the thrust of the propulsion system includes adjusting the thrust based at least in part on a pitch rate of the support platform.

41. The hydrofoiling watercraft of claim 40 wherein to adjust the thrust of the propulsion system based at least in part on the pitch rate includes to amplify a change in thrust responsive to the pitch rate.

42. The hydrofoiling watercraft of claim 41 wherein to amplify the change in thrust includes reducing the thrust proportional to the pitch rate where an upward pitch of the support platform is increasing and increasing the thrust proportional to the pitch rate where the upward pitch of the support platform is decreasing.

43. The hydrofoiling watercraft of claim 37 wherein the orientation behavior includes a pitch acceleration of the support platform derived from the orientation data, wherein to adjust the thrust of the propulsion system includes adjusting the thrust based at least in part on a pitch acceleration of the support platform.

44. The hydrofoiling watercraft of claim 37 further comprising:
a position sensor configured to output position data of the hydrofoiling watercraft relative to a surface of the body of water; and
a speed sensor configured to output speed data of the hydrofoiling watercraft,
wherein the controller is further communicatively coupled to the position sensor and speed sensor, wherein to control the thrust of the propulsion system to position the support platform at the target height includes controlling the thrust based at least in part on a ride height derived from the position data and a speed derived from the speed data to achieve a target ride-height.

45. A method of adjusting a thrust generated by a watercraft including a propulsion system coupled to a bottom surface of a board, the method comprising:
receiving at a ride assist controller a pitch of the watercraft derived from orientation data generated by an orientation sensor of the watercraft; and
calculating in the ride assist controller a thrust command for the propulsion system based on the pitch.

46. The method of claim 45 further comprising:
receiving at the ride assist controller a speed derived from speed data generated by a speed sensor of the watercraft; and
using the ride assist controller to calculate the thrust command based on the speed.

47. The method of claim 45 wherein the watercraft further includes a strut extending from the bottom surface of the board, a hydrofoil disposed along the strut, and wherein the propulsion system is disposed along the strut; the method further comprising:
receiving at the ride assist controller a ride height of the watercraft derived from position data generated by a position sensor of the watercraft; and
calculating in the ride assist controller the thrust command based at least in part on a ride height of the board derived from the position data.

48. The method of claim 47 further comprising:
receiving at the ride assist controller a speed derived from speed data generated by a speed sensor of the watercraft;
wherein using the ride assist controller to calculate the thrust command further comprises selecting a target ride height based on the speed.

49. The method of claim 47 further comprising:
receiving at the ride assist controller a tuning parameter based on a weight of a rider;
wherein using the ride assist controller to calculate the thrust command includes using the tuning parameter to calculate the thrust command based on the ride height.

50. The method of claim 45 further comprising:
receiving location data of the watercraft at the ride assist controller generated by a location sensor of the watercraft,
wherein calculating the thrust command for the propulsion system is further based at least in part on the location data.

51. The method of claim 45 further comprising sending the thrust command to the propulsion system of the watercraft.

52-78. (canceled)
